(19) United States
(12) Patent Application Publication
(10) Pub. No.: US 2025/0193875 A1
(43) Pub. Date: Jun. 12, 2025

(54) RESOURCE SCHEDULING FOR SPARSE NON-ORTHOGONAL TRANSMISSIONS

(71) Applicant: QUALCOMM Incorporated, San Diego, CA (US)

(72) Inventors: Ori SHENTAL, Marlboro, NJ (US); Jing SUN, San Diego, CA (US); Jing JIANG, San Diego, CA (US); Wei YANG, San Diego, CA (US); Junyi LI, Fairless Hills, PA (US); Tao LUO, San Diego, CA (US); Raviteja PATCHAVA, San Diego, CA (US); Xiaoxia ZHANG, San Diego, CA (US)

(21) Appl. No.: 18/531,435

(22) Filed: Dec. 6, 2023

(51) Int. Cl. H04W 72/1268; H04L 5/00; H04W 72/0446; H04W 72/0453; H04W 72/541

(52) U.S. Cl. CPC H04W 72/1268; H04W 72/0446; H04W 72/0453; H04W 72/541; H04L 5/0005

(57) ABSTRACT

Methods, systems, and devices for wireless communications are described. Receiver signal to noise ratio (SNR) (e.g., pathloss and transmission power) may be considered for scheduling of resources for sparse non-orthogonal transmissions. For example, for uplink multi-user scheduling, the network may consider the pathloss and uplink transmission power of each user equipment (UE) (e.g., the receiver SNR) when assigning resources for sparse non-orthogonal multiple access (NOMA) to each UE. As another example, for multilayer transmissions between two devices (e.g., either uplink or downlink), the transmitting device may identify and consider the receiver SNR for each transmission layer when assigning resources for a multi-layer transmission between the two devices.

### FIELD OF TECHNOLOGY

The following relates to wireless communications, including resource scheduling for sparse non-orthogonal transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support resource scheduling for sparse non-orthogonal transmissions. For example, the described techniques provide for consideration of receiver signal to noise ratio (SNR) (e.g., pathloss and transmission power) for sparse scheduling of non-orthogonal transmissions. For example, for uplink multi-user scheduling, the network may consider the pathloss and uplink transmission power of each user equipment (UE) (e.g., the receiver SNR) when assigning resources for sparse non-orthogonal multiple access (NOMA) to each UE. A network entity may transmit scheduling information to the multiple UEs for simultaneous uplink transmissions that indicates a resource assignment vector indicating the assigned resources and a code (e.g., spreading code) to apply for each of the UEs. The UEs may transmit uplink communications in the assigned resources in accordance with the resource assignment vectors. As another example, for multilayer transmissions between two devices (e.g., either uplink or downlink), the transmitting device may identify and consider the receiver SNR for each transmission layer when assigning resources for a multi-layer transmission between the two devices. The transmitting device may transmit scheduling information to the receiving device that indicates a resource assignment matrix that indicates the assigned resources and a repetition code for each of the multiple transmission layers.

A method for wireless communications by UE is described. The method may include transmitting, to a network entity, an indication of a pathloss value for a communication channel between the UE and the network entity and an uplink power for the UE, receiving, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication, and transmitting, to the network entity and via the assigned subset of orthogonal resources, the uplink communication in accordance with the repetition code.

A UE for wireless communications is described. The UE may include one or more memories storing processor executable code, and one or more processors coupled with the one or more memories. The one or more processors may individually or collectively operable to execute the code to cause the UE to transmit, to a network entity, an indication of a pathloss value for a communication channel between the UE and the network entity and an uplink power for the UE, receive, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication, and transmit, to the network entity and via the assigned subset of orthogonal resources, the uplink communication in accordance with the repetition code.

Another UE for wireless communications is described. The UE may include means for transmitting, to a network entity, an indication of a pathloss value for a communication channel between the UE and the network entity and an uplink power for the UE, means for receiving, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication, and means for transmitting, to the network entity and via the assigned subset of orthogonal resources, the uplink communication in accordance with the repetition code.

A non-transitory computer-readable medium storing code for wireless communications is described. The code may include instructions executable by one or more processors to transmit, to a network entity, an indication of a pathloss value for a communication channel between the UE and the network entity and an uplink power for the UE, receive, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication, and transmit, to the network entity and via the assigned subset of orthogonal resources, the uplink communication in accordance with the repetition code.

Some examples of the method, UEs, and non-transitory computer-readable medium described herein may further include operations, features, means, or instructions for transmitting, to the network entity and subsequent to transmission of the uplink communication, an update to at least one of the pathloss value or the uplink power, receiving, from the network entity and based on the update, second scheduling information for a second uplink communication, where the second scheduling information includes a second resource mapping vector indicative of a second assigned subset of orthogonal resources of the set of multiple orthogonal resources and a second repetition code for the second uplink communication, and transmitting, to the network entity and via the second assigned subset of orthogonal resources, the second uplink communication in accordance with the repetition code.

In some examples of the method, UEs, and non-transitory computer-readable medium described herein, a length of the repetition code may be equal to a quantity of orthogonal resources of the set of multiple orthogonal resources.

In some examples of the method, UEs, and non-transitory computer-readable medium described herein, the set of multiple orthogonal resources may be shared for a set of multiple UEs and the set of multiple UEs includes the UE.

In some examples of the method, UEs, and non-transitory computer-readable medium described herein, a quantity of UEs of the set of multiple UEs may be greater than a quantity of orthogonal resources of the set of multiple orthogonal resources.

In some examples of the method, UEs, and non-transitory computer-readable medium described herein, a quantity of assigned orthogonal resources for each of the set of multiple UEs may be equal.

In some examples of the method, UEs, and non-transitory computer-readable medium described herein, the set of multiple orthogonal resources may be a set of multiple frequency resources associated with a same time resource.

In some examples of the method, UEs, and non-transitory computer-readable medium described herein, the assigned subset of orthogonal resources include two or more adjacent frequency resources of the set of multiple frequency resources.

In some examples of the method, UEs, and non-transitory computer-readable medium described herein, transmitting the uplink communication may include operations, features, means, or instructions for transmitting the uplink communication via a set of multiple transmission layers, where the resource mapping vector indicates which orthogonal resource of the assigned subset of orthogonal resources may be assigned to which of the set of multiple transmission layers.

A method for wireless communications by a network entity is described. The method may include obtaining, from a set of multiple UEs, indications of respective pathloss values for respective communication channels between the set of multiple UEs and the network entity and respective uplink powers for the set of multiple UEs, outputting, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications, and obtaining, from the set of multiple UEs via the respective assigned subsets of orthogonal resources, the respective uplink communications in accordance with the respective repetition codes.

A network entity for wireless communications is described. The network entity may include one or more memories storing processor executable code, and one or more processors coupled with the one or more memories. The one or more processors may individually or collectively operable to execute the code to cause the network entity to obtain, from a set of multiple UEs, indications of respective pathloss values for respective communication channels between the set of multiple UEs and the network entity and respective uplink powers for the set of multiple UEs, output, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications, and obtain, from the set of multiple UEs via the respective assigned subsets of orthogonal resources, the respective uplink communications in accordance with the respective repetition codes.

Another network entity for wireless communications is described. The network entity may include means for obtaining, from a set of multiple UEs, indications of respective pathloss values for respective communication channels between the set of multiple UEs and the network entity and respective uplink powers for the set of multiple UEs, means for outputting, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications, and means for obtaining, from the set of multiple UEs via the respective assigned subsets of orthogonal resources, the respective uplink communications in accordance with the respective repetition codes.

A non-transitory computer-readable medium storing code for wireless communications is described. The code may include instructions executable by one or more processors to obtain, from a set of multiple UEs, indications of respective pathloss values for respective communication channels between the set of multiple UEs and the network entity and respective uplink powers for the set of multiple UEs, output, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications, and obtain, from the set of multiple UEs via the respective assigned subsets of orthogonal resources, the respective uplink communications in accordance with the respective repetition codes.

Some examples of the method, network entities, and non-transitory computer-readable medium described herein may further include operations, features, means, or instructions for obtaining, from at least one of the set of multiple UEs, an update to at least one of the respective pathloss values or the respective uplink powers, outputting, to the set of multiple UEs and based on the update, second respective scheduling information for second respective uplink communications for the set of multiple UEs, the second respective scheduling information including second respective resource mapping vectors indicative of second respective assigned subsets of orthogonal resources of the set of multiple orthogonal resources and second respective repetition codes for the second respective uplink communications, and obtaining, from the set of multiple UEs via the second respective assigned subsets of orthogonal resources, the second respective uplink communications in accordance with the second respective repetition codes.

In some examples of the method, network entities, and non-transitory computer-readable medium described herein, a length of the respective repetition codes may be equal to a quantity of orthogonal resources of the set of multiple orthogonal resources.

In some examples of the method, network entities, and non-transitory computer-readable medium described herein, a quantity of UEs of the set of multiple UEs may be greater than a quantity of orthogonal resources of the set of multiple orthogonal resources.

In some examples of the method, network entities, and non-transitory computer-readable medium described herein, a quantity of orthogonal resources in each of the respective assigned subsets of orthogonal resources may be equal.

In some examples of the method, network entities, and non-transitory computer-readable medium described herein, the set of multiple orthogonal resources may be a set of multiple frequency resources associated with a same time resource.

In some examples of the method, network entities, and non-transitory computer-readable medium described herein, the respective assigned subsets of orthogonal resources each include two or more adjacent frequency resources of the set of multiple frequency resources.

In some examples of the method, network entities, and non-transitory computer-readable medium described herein, obtaining the respective uplink communications may include operations, features, means, or instructions for obtaining each of the respective uplink communications via a respective set of multiple transmission layers, where each of the respective resource mapping vectors indicates which orthogonal resources of the respective assigned subsets of orthogonal resources may be assigned to which of the respective set of multiple transmission layers.

A method for wireless communications by a first network node is described. The method may include outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and outputting, to the second network node, the multilayer communication via the respective assigned subsets of orthogonal resources and in accordance with the respective repetition codes for each respective transmission layer.

A first network node for wireless communications is described. The first network node may include one or more memories storing processor executable code, and one or more processors coupled with the one or more memories. The one or more processors may individually or collectively operable to execute the code to cause the first network node to output, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and output, to the second network node, the multilayer communication via the respective assigned subsets of orthogonal resources and in accordance with the respective repetition codes for each respective transmission layer.

Another first network node for wireless communications is described. The first network node may include means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and means for outputting, to the second network node, the multilayer communication via the respective assigned subsets of orthogonal resources and in accordance with the respective repetition codes for each respective transmission layer.

A non-transitory computer-readable medium storing code for wireless communications is described. The code may include instructions executable by one or more processors to output, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and output, to the second network node, the multilayer communication via the respective assigned subsets of orthogonal resources and in accordance with the respective repetition codes for each respective transmission layer.

Some examples of the method, first network nodes, and non-transitory computer-readable medium described herein may further include operations, features, means, or instructions for identifying respective pathloss values for respective communication channels between the first network node and the second network node for the respective set of multiple transmission layers and identifying respective transmission powers for the respective set of multiple transmission layers, where the set of multiple resource mapping vectors may be based on the respective pathloss values and the respective transmission powers.

Some examples of the method, first network nodes, and non-transitory computer-readable medium described herein may further include operations, features, means, or instructions for identifying an update to at least one of the respective pathloss values or the respective transmission powers, outputting, to the second network node, second scheduling information for a second multilayer communication from the first network node to the second network node, the second scheduling information including a second set of multiple resource mapping vectors for the respective set of multiple transmission layers for the multilayer communication, where the second set of multiple resource mapping vectors may be indicative of respective second assigned subsets of orthogonal resources of the set of multiple orthogonal resources and respective second repetition codes for the second multilayer communication for the respective transmission layers of the respective set of multiple transmission layers, where the second set of multiple resource mapping vectors may be based on the update, and outputting, to the second network node, the second multilayer communication via the respective second assigned subsets of orthogonal resources and in accordance with the respective second repetition codes for each respective transmission layer.

In some examples of the method, first network nodes, and non-transitory computer-readable medium described herein, a length of each of the respective repetition codes may be equal to a quantity of orthogonal resources of the set of multiple orthogonal resources.

In some examples of the method, first network nodes, and non-transitory computer-readable medium described herein, a quantity of layers of the respective set of multiple transmission layers may be greater than a quantity of orthogonal resources of the set of multiple orthogonal resources.

In some examples of the method, first network nodes, and non-transitory computer-readable medium described herein, a quantity of orthogonal resources in each of the respective assigned subsets of orthogonal resources may be equal.

In some examples of the method, first network nodes, and non-transitory computer-readable medium described herein, the set of multiple orthogonal resources may be a set of multiple frequency resources associated with a same time resource.

In some examples of the method, first network nodes, and non-transitory computer-readable medium described herein, each of the respective assigned subsets of orthogonal resources include two or more adjacent frequency resources of the set of multiple frequency resources.

In some examples of the method, first network nodes, and non-transitory computer-readable medium described herein, outputting the multilayer communication may include operations, features, means, or instructions for outputting an uplink communication to a network entity, where the first network node may be a UE, and where the second network node may be the network entity.

In some examples of the method, first network nodes, and non-transitory computer-readable medium described herein, outputting the multilayer communication may include operations, features, means, or instructions for outputting a downlink communication to a UE, where the first network node may be a network entity, and where the second network node may be the UE.

A method for wireless communications by a second network node is described. The method may include obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and obtaining, from the first network node, the multilayer communication via the respective assigned subsets of orthogonal resources and in accordance with the respective repetition codes for each respective transmission layer.

A second network node for wireless communications is described. The second network node may include one or more memories storing processor executable code, and one or more processors coupled with the one or more memories. The one or more processors may individually or collectively operable to execute the code to cause the second network node to obtain, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and obtain, from the first network node, the multilayer communication via the respective assigned subsets of orthogonal resources and in accordance with the respective repetition codes for each respective transmission layer.

Another second network node for wireless communications is described. The second network node may include means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and means for obtaining, from the first network node, the multilayer communication via the respective assigned subsets of orthogonal resources and in accordance with the respective repetition codes for each respective transmission layer.

A non-transitory computer-readable medium storing code for wireless communications is described. The code may include instructions executable by one or more processors to obtain, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers and obtain, from the first network node, the multilayer communication via the respective assigned subsets of orthogonal resources and in accordance with the respective repetition codes for each respective transmission layer.

In some examples of the method, second network nodes, and non-transitory computer-readable medium described herein, the set of multiple resource mapping vectors may be based on respective pathloss values for respective communication channels between the first network node and the second network node for the respective set of multiple transmission layers and respective transmission powers for the respective set of multiple transmission layers.

Some examples of the method, second network nodes, and non-transitory computer-readable medium described herein may further include operations, features, means, or instructions for obtaining, from the first network node and based on an update to at least one of the respective pathloss values or the respective transmission powers, second scheduling information for a second multilayer communication from the first network node to the second network node, the second scheduling information including a second set of multiple resource mapping vectors for the respective set of multiple transmission layers for the multilayer communication, where the second set of multiple resource mapping vectors may be indicative of respective second assigned subsets of orthogonal resources of the set of multiple orthogonal resources and respective second repetition codes for the second multilayer communication for the respective transmission layers of the respective set of multiple transmission layers, where the second set of multiple resource mapping vectors may be based on the update and obtaining, from the first network node, the second multilayer communication via the respective second assigned subsets of orthogonal resources and in accordance with the respective second repetition codes for each respective transmission layer.

In some examples of the method, second network nodes, and non-transitory computer-readable medium described herein, a length of each of the respective repetition codes may be equal to a quantity of orthogonal resources of the set of multiple orthogonal resources.

In some examples of the method, second network nodes, and non-transitory computer-readable medium described herein, a quantity of layers of the respective set of multiple transmission layers may be greater than a quantity of orthogonal resources of the set of multiple orthogonal resources.

In some examples of the method, second network nodes, and non-transitory computer-readable medium described herein, a quantity of orthogonal resources in each of the respective assigned subsets of orthogonal resources may be equal.

In some examples of the method, second network nodes, and non-transitory computer-readable medium described herein, the set of multiple orthogonal resources may be a set of multiple frequency resources associated with a same time resource.

In some examples of the method, second network nodes, and non-transitory computer-readable medium described herein, each of the respective assigned subsets of orthogonal resources include two or more adjacent frequency resources of the set of multiple frequency resources.

In some examples of the method, second network nodes, and non-transitory computer-readable medium described herein, obtaining the multilayer communication may include operations, features, means, or instructions for obtaining an uplink communication from a UE, where the first network node may be the UE, and where the second network node may be a network entity.

In some examples of the method, second network nodes, and non-transitory computer-readable medium described herein, obtaining the multilayer communication may include operations, features, means, or instructions for obtaining a downlink communication from a network entity, where the first network node may be the network entity, and where the second network node may be a UE.

### BRIEF DESCRIPTION OF THE DRAWINGS

FIG. 1 shows an example of a wireless communications system that supports resource scheduling for sparse non-orthogonal transmissions in accordance with one or more aspects of the present disclosure.

FIG. 2 shows an example of a wireless communications system that supports resource scheduling for sparse non-orthogonal transmissions in accordance with one or more aspects of the present disclosure.

FIG. 3 shows an example of a transmission scheme that supports resource scheduling for sparse non-orthogonal transmissions in accordance with one or more aspects of the present disclosure.

FIG. 4 shows an example of a resource diagram that supports resource scheduling for sparse non-orthogonal transmissions in accordance with one or more aspects of the present disclosure.

FIG. 5 shows an example of a transmission scheme that supports resource scheduling for sparse non-orthogonal transmissions in accordance with one or more aspects of the present disclosure.

FIG. 6 shows an example of a resource diagram that supports resource scheduling for sparse non-orthogonal transmissions in accordance with one or more aspects of the present disclosure.

FIG. 7 shows an example of a process flow that supports resource scheduling for sparse non-orthogonal transmissions in accordance with one or more aspects of the present disclosure.

FIG. 8 shows an example of a process flow that supports resource scheduling for sparse non-orthogonal transmissions in accordance with one or more aspects of the present disclosure.

FIGS. 9 and 10 show block diagrams of devices that support resource scheduling for sparse non-orthogonal transmissions in accordance with one or more aspects of the present disclosure.

FIG. 11 shows a block diagram of a communications manager that supports resource scheduling for sparse non-orthogonal transmissions in accordance with one or more aspects of the present disclosure.

FIG. 12 shows a diagram of a system including a device that supports resource scheduling for sparse non-orthogonal transmissions in accordance with one or more aspects of the present disclosure.

FIGS. 13 and 14 show block diagrams of devices that support resource scheduling for sparse non-orthogonal transmissions in accordance with one or more aspects of the present disclosure.

FIG. 15 shows a block diagram of a communications manager that supports resource scheduling for sparse non-orthogonal transmissions in accordance with one or more aspects of the present disclosure.

FIG. 16 shows a diagram of a system including a device that supports resource scheduling for sparse non-orthogonal transmissions in accordance with one or more aspects of the present disclosure.

FIGS. 17 through 20 show flowcharts illustrating methods that support resource scheduling for sparse non-orthogonal transmissions in accordance with one or more aspects of the present disclosure.

### DETAILED DESCRIPTION

Some wireless communication systems may implement non-orthogonal multiple access (NOMA), via which multiple devices (e.g., user equipments (UEs)) may transmit in the same orthogonal resources (e.g., subcarriers). In NOMA, spreading codes or sequences may be used such that a receiver can distinguish which signal was transmitted by which device over the same resource. The implementation of NOMA may increase spectral efficiency by allowing for concurrent users on the same time and frequency resources. In sparse NOMA, each transmitting device utilizes a small portion of the available orthogonal physical resources (e.g., out of 12 subcarriers, each transmitting device may use 2 subcarriers). Schemes for mapping different users to the various orthogonal resources in sparse NOMA may include: 1) regular mapping where each transmitting device occupies a fixed quantity of resources and each resource is used by a fixed quantity of transmitting devices; 2) irregular mapping where each transmitting device occupies a random quantity of resources and each resource is used by a random quantity of transmitting devices; and 3) partly-regular mapping where each transmitting device occupies a fixed quantity of resources and each resource is used by a random quantity of transmitting device (which may be fixed on average). Regular scheduling may be the most efficient for a Gaussian channel (e.g., an additive white Gaussian noise (AWGN) channel). For channels with large scale fading characteristics (e.g., due to pathloss), however, different resource assignments may be optimal depending on the pathloss.

For uplink multi-user scheduling, the network may consider the pathloss and uplink transmission power of each UE (e.g., the receiver signal to noise ratio (SNR)) when assigning resources for sparse NOMA to each UE. For example, the network may assign d resources out of each of the M orthogonal resources to each of K UEs, where K≥M. The d resources assigned to each of the K UEs may depend on the pathloss and uplink transmission power of each UE. A network entity may transmit scheduling information to the multiple UEs for simultaneous uplink transmissions that indicates a resource assignment vector indicating the assigned resources and a code (e.g., spreading code) to apply for each of the UEs. The UEs may transmit uplink communications in the assigned resources in accordance with the resource assignment vectors. Such assignment of resources may increase the spectral efficiency of the multi-user uplink communication as compared to regular scheduling for non-Gaussian channels.

A transmitting device may also consider the receiver SNR for each transmission layer when assigning resources for multi-layer transmissions between two devices (e.g., either for downlink or uplink). For example, the transmitting device may determine the pathloss and transmission power for each transmission layer. In some examples, for a multilayer communication, the pathloss may be the same for each layer. Based on the receiver SNR for each transmission layer, the transmitting device may assign d resources out of each of the M orthogonal resources to each of K layers, where K≥M. The transmitting device may transmit scheduling information to the receiving device that indicates a resource assignment matrix that indicates the assigned resources and a code for each of the multiple transmission layers. Such assignment of resources may increase the spectral efficiency of multi-layer communications as compared to regular scheduling for non-Gaussian channels.

Aspects of the disclosure are initially described in the context of wireless communications systems. Aspects of the disclosure are further illustrated by and described with reference to transmission schemes, resource diagrams, process flows, apparatus diagrams, system diagrams, and flowcharts that relate to resource scheduling for sparse non-orthogonal transmissions.

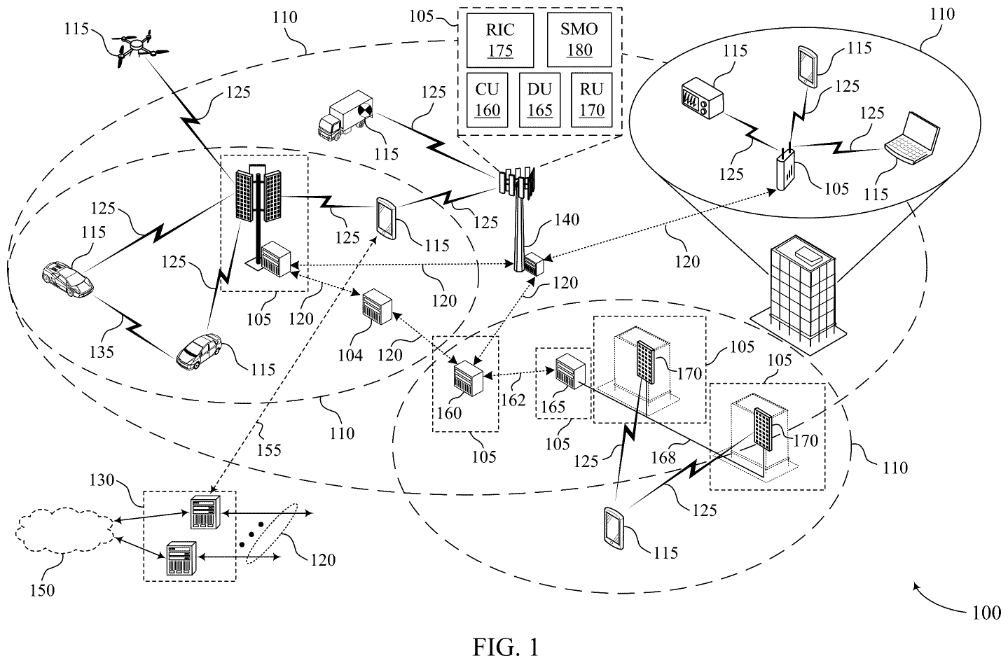

FIG. 1 shows an example of a wireless communications system 100 that supports resource scheduling for sparse non-orthogonal transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource scheduling for sparse non-orthogonal transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, SNR, or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may implement NOMA, via which multiple devices (e.g., UEs 115) may transmit in the same orthogonal resources (e.g., subcarriers). In NOMA, spreading codes or sequences may be used such that a receiver can distinguish which signal was transmitted by which device over the same resource. NOMA may enable high spectrum efficiency (SPEF) by allowing multiple users to share the same resources. In sparse NOMA, each transmitting device utilizes a small portion of the available orthogonal physical resources (e.g., out of 12 subcarriers, each transmitting device may use 2 subcarriers). A code division multiple access (CDMA) analogy to sparse NOMA may be each user being allocated a different (non-orthogonal) sparse spreading code, with most chips equal to zero, instead of a dense pseudo binary sequence.

Schemes for mapping different users to the various orthogonal resources in sparse NOMA may include: 1) regular mapping where each transmitting device occupies a fixed quantity of resources and each resource is used by a fixed quantity of transmitting devices; 2) irregular mapping where each transmitting device occupies a random quantity of resources and each resource is used by a random quantity of transmitting devices; and 3) partly-regular mapping where each transmitting device occupies a fixed quantity of resources and each resource is used by a random quantity of transmitting device (which may be fixed on average). Regular mapping may be the most efficient for a Gaussian channel from among regular, irregular, and partly-regular mapping. Regular mapping for sparse NOMA may provide better sum-rate capacity than dense NOMA for a Gaussian channel, where in dense NOMA each user occupies the entire set of available resources. For channels with large scale fading characteristics (e.g., due to pathloss), however, different resources may be optimal depending on the pathloss.

Greedy algorithms may be used for SPEF-optimized mapping of a same quantity (e.g., a quantity d) of resources across UEs 115 in a grant-based (e.g., scheduled) NOMA system or across layers for a single-user multilayer transmission. For example, a network entity 105 may use a greedy algorithm to map resources across UEs 115 for multiuser uplink. As another example, for a single-user multilayer transmission, a greedy algorithm may be run at the UE 115 for an uplink transmission or at the network entity 105 for a downlink transmission. For a fading channel, the described algorithms are shown to yield an improved SPEF with respect to grant-based (e.g., with regular sparse mapping) and grant-free (with either irregular or partly-regular mapping) sparse NOMA. For a Gaussian channel, the described algorithms coincide with the optimally proven regular sparse mapping.

For uplink multi-user scheduling, the greedy algorithm used by the network entity 105 may consider the pathloss and uplink transmission power of each UE 115 (e.g., the receiver SNR) when assigning resources for sparse NOMA to each UE 115. For example, the network may assign d resources out of each of the M orthogonal resources to each of K UEs, where K≥M. The d resources assigned to each of the K UEs 115 may depend on the pathloss and uplink transmission power of each UE 115. The network entity 105 may transmit scheduling information to the multiple UEs 115 for simultaneous uplink transmissions that indicates a resource assignment vector indicating the assigned resources and a code (e.g., spreading code) to apply for each of the UEs 115. The UEs 115 may transmit uplink communications in the assigned resources in accordance with the resource assignment vectors.

For single-user multilayer transmissions, the greedy algorithm used by the transmitting device (e.g., a UE 115 for uplink or a network entity 105 for downlink) may consider the receiver SNR for each transmission layer when assigning resources for a multilayer transmission. For example, the transmitting device may determine the pathloss and transmission power for each transmission layer. In some examples, for a multilayer communication, the pathloss may be the same for each layer. Based on the receiver SNR for each transmission layer, the transmitting device may assign d resources out of each of the M orthogonal resources to each of K layers, where K≥M. The transmitting device may transmit scheduling information to the receiving device that indicates a resource assignment matrix that indicates the assigned resources and a code for each of the multiple transmission layers.

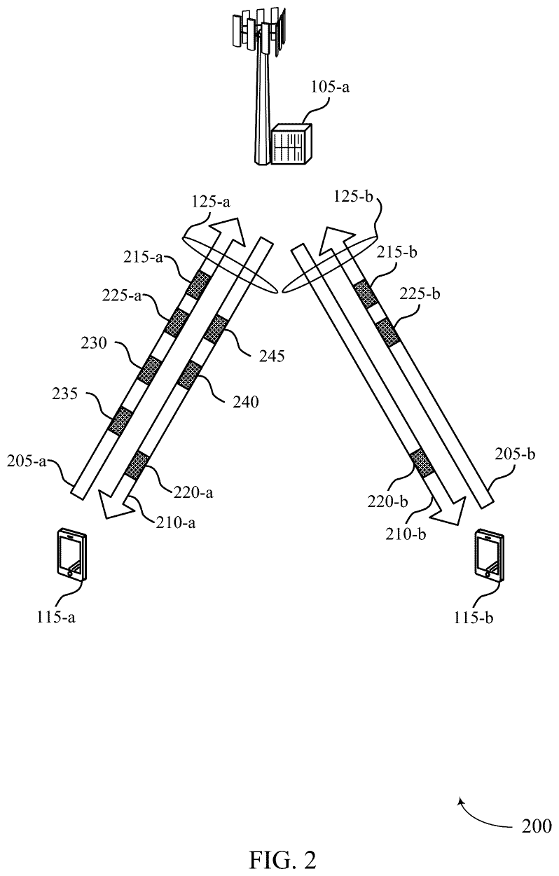

FIG. 2 shows an example of a wireless communications system 200 that supports resource scheduling for sparse non-orthogonal transmissions in accordance with one or more aspects of the present disclosure. The wireless communications system 200 may implement aspects of or may be implemented by aspects of the wireless communications system 100. For example, the wireless communications system 200 includes a UE 115-a and a UE 115-b, which may be examples of a UE 115 described herein with respect to FIG. 1. The wireless communications system 200 also includes a network entity 105-a, which may be an example of a network entity 105 as described herein with respect to FIG. 1.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-a. The communication link 125-a and the communication link 125-b may include bi-directional links that enable both uplink and downlink communications. For example, the UE 115-a may transmit the uplink signals 205-a (e.g., uplink transmissions), such as uplink control signals or uplink data signals, to the network entity 105-a using the communication link 125-a and the network entity 105-a may transmit downlink signals 210-a (e.g., downlink transmissions), such as downlink control signals or downlink data signals, to the UE 115-a using the communication link 125-a. The UE 115-b may transmit uplink signals 205-b (e.g., uplink transmissions), such as uplink control signals or uplink data signals, to the network entity 105-a using the communication link 125-b and the network entity 105-a may transmit downlink signals 210-b (e.g., downlink transmissions), such as downlink control signals or downlink data signals, to the UE 115-b using the communication link 125-b.

In some examples, the wireless communications system 200 may implement sparse NOMA for multi-user uplink. For example, the network entity 105-a may identify a receiver SNR for each of a set of UEs 115 (e.g., K UEs 115) including the UE 115-a and the UE 115-b that will be scheduled for sparse NOMA, where the receiver SNR refers to the SNR at the network entity 105-a for uplink signals 205. For example, the UE 115-a may transmit control signaling 215-a that indicates a pathloss for the channel between the UE 115-a and the network entity 105-a and an uplink transmission power for the UE 115-a. Similarly, the UE 115-b may transmit control signaling 215-b that indicates a pathloss for the channel between the UE 115-b and the network entity 105-a and an uplink transmission power for the UE 115-b. The network entity 105-a may assign resources (e.g., d resources) from a set of possible orthogonal resources (e.g., M possible orthogonal resources) to each of the UEs 115 based on the receiver SNR for each of a set of UEs 115 (e.g., using a greedy algorithm as described herein). The network entity 105-a may transmit scheduling information 220 for uplink communications for each of the UEs 115, where each scheduling information 220 includes a resource mapping vector indicative of the assigned orthogonal resources and a repetition code for each UE 115 to apply. For example, the network entity 105-a may transmit scheduling information 220-a to the UE 115-a that includes a resource mapping vector that indicates the assigned resources and repetition code to apply for an uplink transmission 225-a. The network entity 105-a similarly may transmit scheduling information 220-b to the UE 115-b that includes a resource mapping vector that indicates the assigned resources and repetition code to apply for an uplink transmission 225-b. The UE 115-a may transmit the uplink transmission 225-a using the assigned resources and repetition code indicated by the resource mapping vector in the scheduling information 220-a, and the UE 115-b may transmit the uplink transmission 225-b using the assigned resources and repetition code indicated by the resource mapping vector in the scheduling information 220-b. Uplink transmissions 225 from the multiple UEs 115 (e.g., including the UE 115-a and the UE 115-b) may be received via the same orthogonal resources. The network entity 105-a may identify which UE 115 each uplink transmission 225 is received from based on the repetition codes.

As described herein, the transmitting device may consider the receiver SNR for each transmission layer when assigning resources for multi-layer transmissions between two devices (e.g., either for downlink or uplink), where the receiver SNR maybe based on the pathloss and transmission power. In some examples, the pathloss may be the same for each layer, and accordingly the transmitting device may determine the assignment of resources based on the transmission power for each layer.

For example, for uplink, the UE 115-a may identify respective pathloss values and transmission powers for each of a set of layers of a communication channel between the UE 115-a and the network entity 105-a. The UE 115-a may transmit, to the network entity 105-a, scheduling information 230 that includes a set of resource mapping vectors corresponding to the set of layers. Each resource mapping vector may indicate the assigned resources (e.g., d resources) from a set of possible orthogonal resources (e.g., M possible orthogonal resources) and a repetition code for the corresponding layer (e.g., for K layers). The UE 115-a may transmit a multilayer uplink transmission 235 over the K layers using the assigned resources and repetition code for each layer, and accordingly the network entity 105-a may decode the multilayer uplink transmission 235.

As another example, for downlink, the network entity 105-a may identify respective pathloss values and transmission powers for each of a set of layers of a communication channel between the UE 115-a and the network entity 105-a. The network entity 105-a may transmit, to the UE 115-a, scheduling information 240 that includes a set of resource mapping vectors corresponding to the set of layers. Each resource mapping vector may indicate the assigned resources (e.g., d resources) from a set of possible orthogonal resources (e.g., M possible orthogonal resources) and a repetition code for the corresponding layer (e.g., for K layers). The network entity 105-a may transmit a multilayer downlink transmission 245 over the K layers using the assigned resources and repetition code for each layer, and accordingly the UE 115-a may decode the multilayer downlink transmission 245.

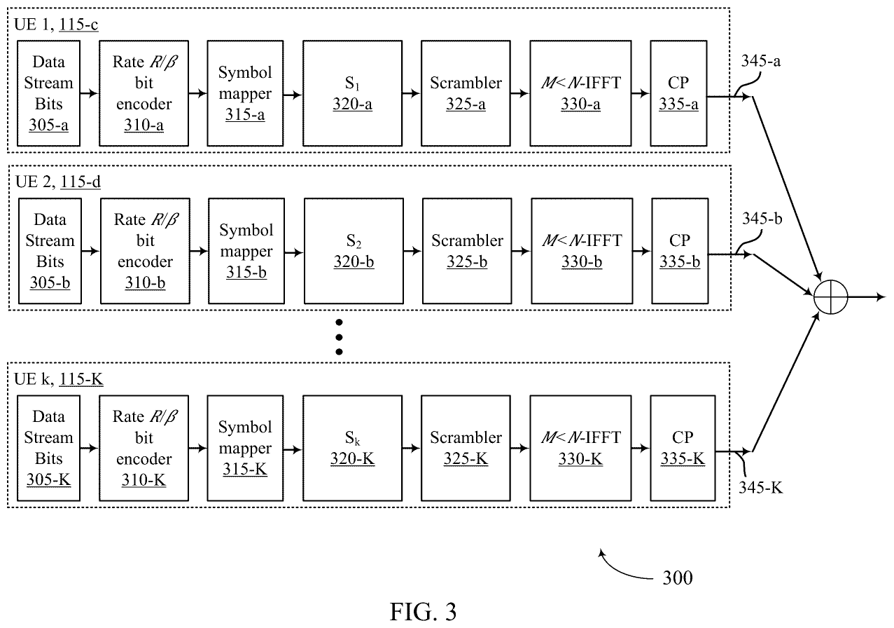

FIG. 3 shows an example of a transmission scheme 300 that supports resource scheduling for sparse non-orthogonal transmissions in accordance with one or more aspects of the present disclosure. The transmission scheme 300 may implement aspects of or may be implemented by aspects of the wireless communications system 100 or the wireless communications system 200. For example, the transmission scheme 300 may include a set of multiple UEs 115 including a UE 115-c, a UE 115-d, and a UE 115-K, which may be UEs 115 as described herein. The transmission scheme 300 may implement multi-user uplink transmissions for K UEs 115 as described herein.

Each UE 115 may receive a data stream of bits 305 for transmission (e.g., the UE 115-c may receive a data stream of bits 305-a, the UE 115-d may receive a data stream of bits 305-b, and the UE 115-K may receive a data stream of bits 305-K). Each UE 115 may encode the stream of data bits using an encoder 310 at a rate of R/B. β may be an integer greater than 1 and K=βM, where M is the total quantity of orthogonal resources. For example, the UE 115-c may encode the data stream of bits 305-a using the encoder 310-a, the UE 115-d may encode the data stream of bits 305-b using the encoder 310-b, and UE 115-K may encode the data stream of bits 305-a using the encoder 310-K. Each UE 115 may map the encoded bit streams to one or more symbols using a symbol mapper 315. For example, the UE 115-c may map the encoded data stream to one or more symbols using the symbol mapper 315-a, the UE 115-d may map the encoded data stream to one or more symbols using the symbol mapper 315-b, and the UE 115-K may map the encoded data stream to one or more symbols using the symbol mapper 315-K.

As described herein, the network entity 105 may transmit a resource mapping vector to each UE 115 that indicates which d resources of the M orthogonal resources to use and a repetition code. The repetition code may spread the encoded data stream across the M resources via repeating the encoded data stream and applying a coded value to the repetitions such that codes provided to UEs that use the same non-orthogonal resources are orthogonal. The length of the repetition code may be M with entries of either “0” (M-d of the entries have a value of “0”) or of unit value phase (d of the entries have unit value phase) of the form e^{j/φ}. For example, entries may be taken from the alphabet {0, −1, 1}. The rate of the repetition code may be 1/M as each symbol may be repeated M times (where some or most of the repetitions may be null, thereby providing sparsity). At 320, each UE 115 may apply the resource mapping vector s 320 to the mapped symbols. For example, the UE 115-c may apply the resource mapping vector s₁ 320-a which may output a length M vector, the UE 115-d may apply the resource mapping vector s₂ 320-b which may output a length M vector, and the UE 115-K may apply the resource mapping vector s_{K} 320-K which may output a length M vector. Each UE 115 may scramble the output of the resource mapping vector s using a scrambler 325 (e.g., the UE 115-c may scramble the output of the resource mapping vector s₁ 320-a using the scrambler 325-a, the UE 115-d may scramble the output of the resource mapping vector s₂ 320-b using the scrambler 325-b, and the UE 115-K may scramble the output of the resource mapping vector s_{K} 320-K using the scrambler 325-K). Each UE 115 may apply a length N inverse fast Fourier transform (IFFT) 330 to generate a waveform and may apply a cyclic prefix 335 and transmit the waveform with the cyclic prefix as an uplink transmission 345. N may be greater than M. For example, the UE 115-c may apply a length N IFFT 330-a to the output of the scrambler 325-a to generate a waveform. The UE 115-c may apply a cyclic prefix 335-a to the generated waveform and may transmit the waveform with the cyclic prefix as an uplink transmission 345-a. The UE 115-d may apply a length N IFFT 330-b to the output of the scrambler 325-b to generate a waveform. The UE 115-d may apply a cyclic prefix 335-b to the generated waveform and may transmit the waveform with the cyclic prefix as an uplink transmission 345-b. The UE 115-K may apply a length N IFFT 330-K to the output of the scrambler 325-K to generate a waveform. The UE 115-K may apply a cyclic prefix 335-K to the generated waveform and may transmit the waveform with the cyclic prefix as an uplink transmission 345-K.

The network entity 105 may receive the uplink transmissions 345 via the M orthogonal resources. The network entity 105 may identify which uplink transmission 345 is from which UE 115 based on the repetition codes.

To design the resource mapping vectors s, the network entity 105 may assume that a given UE 115 (e.g., UEₖ) has power Pₖ to allocate across dₖ=d out of M orthogonal resources (e.g., M subcarriers) (same d ∇k). The network entity 105 may apply an algorithm to determine which d subcarriers to assign to each UE 115 in order to equalize and enhance (e.g., maximize) the multiuser efficiency n across subcarriers. A linear minimum mean square error (LMMSE) receiver may enhance (e.g., maximize) SINRₖ which may refer to the signal to interference and noise ratio of a given UE 115 (e.g., UEₖ). For example, SNR may be the SNR for a single user UE 115 (e.g., UEₖ) at the output of the discrete Fourier transform (DFT) at the receiver (e.g., the network entity 105 with no multiple access interference (MAI)). In such cases with no MAI, SINRₖ=SNRₖ. ηₖ, where 0≤ηₖ≤1 may be referred to as the UEₖ's multiuser efficiency (ME). The

$${lim}_{K \to ∞} {η}_{k} = η ,$$

ηₖ=η, and accordingly in a large system the limit of the ME may be identical across UEs 115. The network entity 105 may achieve an approximate of this asymptotic behavior in a finite system case on a subcarrier by subcarrier basis, as subcarrier level SINR may be proportional to subcarrier level received SNR. The asymptotic non-fading multiuser efficiency may be the solution to

$$η = {[ 1 + β \frac{S N {R}_{R x}}{S N {R}_{R x} \cdot η + 1} ]}^{- 1} .$$

For example, assuming that small-scale fading is Rayleigh scattering and that large scale fading, αₖ (e.g., pathloss and/or shadowing), is deterministic per user, different subcarriers may be statistically indifferent in terms of fading. Thus, a given UE 115 (e.g., UEₖ) may allocate its transmit power Pₖ evenly across d out of the M subcarriers, and therefore

$${s}_{f k} = \{ 0 , \sqrt{\frac{{P}_{k}}{d}} \} ,$$

where f={1, . . . , M}, k={1, . . . , k}. For a flat fading channel,

$$η = {[ 1 + β E [ \frac{S N {R}_{R x}}{S N {R}_{R x} η + 1} ] ]}^{- 1} .$$

To generate the sparse code matrix (e.g., the set of resource mapping vectors S=[s₁, . . . , sₖ]) dependent only on the large scale fading, a deterministic n value may be calculated as shown in equation 1.

$$η = {lim}_{K \to ∞} {[ 1 + \frac{1}{M} {\sum }_{k = 1}^{K} \frac{{SNR}_{k} {α}_{k}^{2}}{S N {R}_{k} {α}_{k}^{2} \cdot η + 1} ]}^{- 1} \qquad ( 1 )$$

The asymptotic behavior of n may be approximated in a finite system case on a subcarrier by subcarrier basis. Accordingly per a single subcarrier f (e.g., for M=1), the summation as in equation (1) for the ME for the subcarrier f, η_{f}, is over the UEs 115 contributing to the subcarrier (e.g., transmitting over the subcarrier) and may be given by equation 2, where σ² is the noise variance.

$${η}_{f} = η = {[ 1 + {\sum }_{k i n f} {S}_{f k}^{2} \frac{{α}_{k}^{2}}{{P}_{k} {α}_{k}^{2} \cdot η + {σ}^{2}} ]}^{- 1} ∀ f \qquad ( 2 )$$

Equation 3 shows a fixed point equation for the asymptotic ME n in terms of receiver SNR for each of K UEs 115. The network entity may apply a greedy algorithm to equalize the ME across subcarriers as in equation 2 when generating the sparse code matrix (e.g., the set of resource mapping vectors s=[s₁, . . . , s_{K}]).

$$η = {[ 1 + \frac{1}{M} {\sum }_{k = 1}^{K} \frac{S N {R}_{k} {α}_{k}^{2}}{S N {R}_{k} {α}_{k}^{2} \cdot η + 1} ]}^{- 1} \qquad ( 3 )$$

Letting

$${δ}_{k} = \frac{{α}_{k}^{2}}{{P}_{k} {α}_{k}^{2} \cdot η + {σ}^{2}} ,$$

then equation 3 becomes η_{f}=η=[1+Σ_{k in f} S_{fk}²δk]⁻¹ ∇f. In a first stage of the greedy algorithm, out of all the UEs 115 which have not yet allocated their power into d subcarriers, the network entity 105 finds the UE k′ for which k′=arg max 8k (e.g., the most ME-influential UE 115). At a second stage of the greedy algorithm, the network entity 105 calculates ρ_{f} as ρ_{f}=Σ_{k in f} S_{fk}²δₖ, and thus η_{f}=[1+ρ_{f}]⁻¹. At a third stage of the greedy algorithm, the network entity 105 finds the subcarrier out of the subcarriers that were not already assigned to the UE k′ for which

$${f}^{′} = {arg}_{f} min {ρ}_{f}$$

(adding MAI to the subcarrier with the maximal ME). At a fourth stage of the greedy algorithm, the network entity 105 sets S_{f′k′}=\sqrt{Pₖ/d}. The network entity 105 returns to the first stage until all K UEs 115 have respective transmission powers allocated into d subcarriers.

The greedy algorithm may be run at the network entity 105 which receives the multi-user uplink transmissions and may be based on the SNR_{RX} values for each of the K UEs 115 (e.g., the K UEs 115 may indicate pathloss values and uplink transmission powers to the network entity 105). Absent power control commands from the network entity 105 to the UEs 115, the set of resource mapping vectors s=[s₁, . . . , s_{K}] may be updated when the uplink transmission powers or the pathlosses change for the K UEs 115. Under uplink power control (e.g., equal received SNRs), the scheduling may become fully regular. Any change in the UE 115 transmission power or pathloss profile may result in a new resource allocation (e.g., an update to the set of resource mapping vectors s=[s₁, . . . , s_{K}]).

As an example, the greedy algorithm may be used given K=36, and N=12, and accordingly β=3. In the example, Pₖ=30 dBm and σ²=−60 dBm, large scale fading is due to pathloss uniformly distributed in [−140−60] dB, 100 UE drops, and small scale fading is uncorrelated Rayleigh fading at 1000 realizations per UE drop. In such an example, the described greedy algorithm for sparse NOMA may have a higher spectral efficiency than regular mapping (e.g., (d,βd)—Gallager construction), semi-regular mapping where each UE 115 transmits a symbol in d randomly selected subcarriers, irregular mapping where each UE 115 transmits in a random quantity of subcarriers where the total quantity of subcarriers across the UEs 115 is drawn from a Poisson distribution with a mean of d, dense NOMA with

$${S}_{f k} = \frac{1}{\sqrt{M}}$$

and orthogonal transmissions among the UEs 115. For example, when d=1, the spectral efficiency of the described greedy algorithm for sparse NOMA may be 102% of dense NOMA, when d=2, the spectral efficiency of the described greedy algorithm for sparse NOMA may be 101% of dense NOMA, and when d=3, the spectral efficiency of the described greedy algorithm for sparse NOMA may be 100% of dense NOMA. For the multi-user uplink case as described herein, the sum capacity gain with respect to semi-regular resource scheduling may be approximately 20% for d=1 and approximately 5% for d=2.

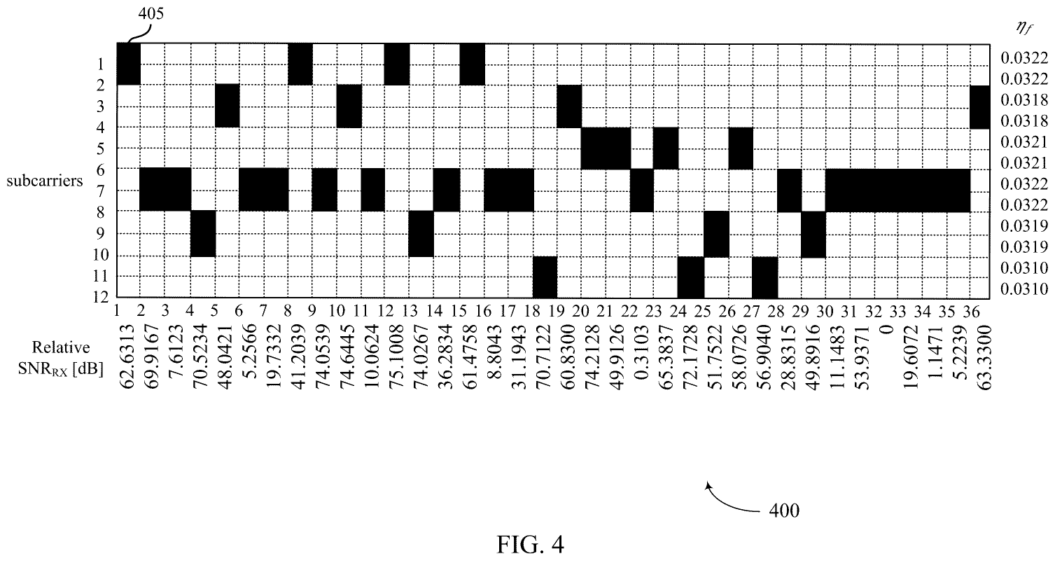

FIG. 4 shows an example of a resource diagram 400 that supports resource scheduling for sparse non-orthogonal transmissions in accordance with one or more aspects of the present disclosure. The resource diagram 400 may implement aspects of or may be implemented by aspects of the wireless communications system 100, the wireless communications system 200, or the transmission scheme 300.

For example, the resource diagram 400 shows an example of assigned resources 405 for 12 subcarriers (M=12 subcarriers) where d=2 subcarriers for K=36 UEs, and the asymptotic η=0.0319. The assigned resources 405 are mapped to the 36 UEs based on the η_{f} of the subcarrier and the relative SNR_{RX} values for each of the 36 UEs 115. SPEF may be invariant to row/column permutations, and as shown ME for the subcarriers η_{f} may be approximately equalized.

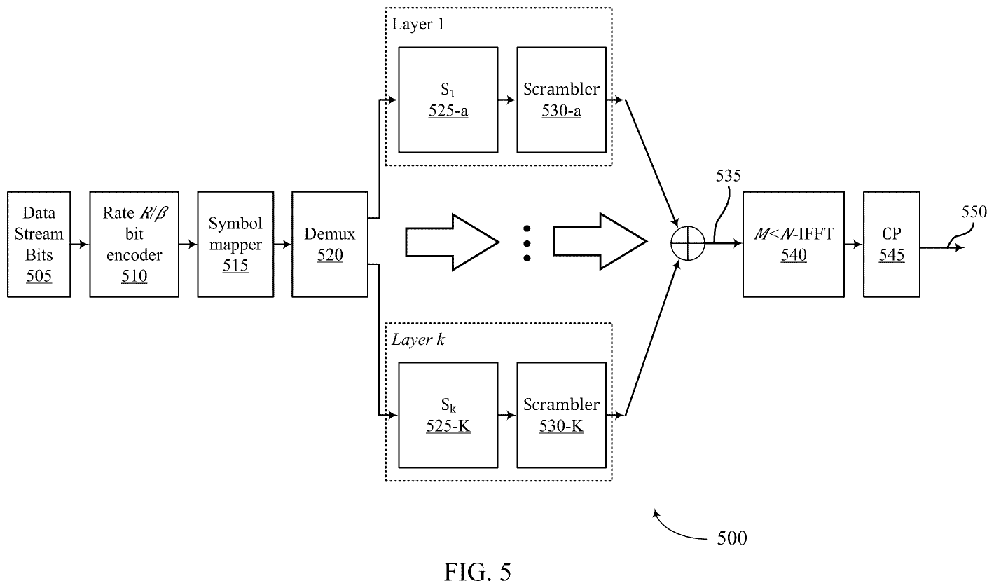

FIG. 5 shows an example of a transmission scheme 500 that supports resource scheduling for sparse non-orthogonal transmissions in accordance with one or more aspects of the present disclosure. The transmission scheme 500 may implement aspects of or may be implemented by aspects of the wireless communications system 100 or the wireless communications system 200. For example, the transmission scheme 500 may be implemented by a transmitting device such as a UE 115 or a network entity 105 as described herein. The transmission scheme 300 may implement multilayer transmissions for K layers as described herein.

The transmitting device (e.g., a UE 115 or a network entity 105) may receive a data stream of bits 505 for transmission. The transmitting device may encode the stream of data bits using an encoder 510 at a rate of R/β. β may be an integer greater than 1 and K=βM, where M is the total quantity of orthogonal resources. The transmitting device may map the encoded bit streams to one or more symbols using a symbol mapper 515. A demultiplexer 520 may demultiplex the mapped symbols to the K layers.

At 525, the transmitting device may apply the resource corresponding mapping vector s to each respective symbol for each of the K layers. For example, layer 1 may apply the resource mapping vector s₁ 525-a which may output a length M vector and layer K may apply the resource mapping vector s_{K} 525-K which may output a length M vector. The resource mapping vectors s may indicate which d resources of the M orthogonal resources to use and a repetition code. The repetition code may spread the encoded data stream across the M resources via repeating the encoded data stream and applying a coded value to the repetitions such that codes provided to different layers that use the same non-orthogonal resources are orthogonal. The length of the repetition code may be M with entries of either “0” (M-d of the entries have a value of “0”) or of unit value phase (d of the entries have unit value phase) of the form

$${e}^{\frac{j}{φ}} .$$

For example, entries may be taken from the alphabet {0, −1, 1}. The rate of the repetition code may be 1/M as each symbol may be repeated M times (where some or most of the repetitions may be null, thereby providing sparsity).

The transmitting device may scramble the output of each resource mapping vector s using a scrambler 530 (e.g., for layer 1 the transmitting device may scramble the output of the resource mapping vector s₁ 525-a using the scrambler 530-a and for layer K the transmitting device may scramble the output of the resource mapping vector s_{K} 525-K using the scrambler 530-K).

The transmitting device may apply a length N IFFT 540 to the output 535 of the scramblers 530 to generate a waveform and may apply a cyclic prefix 545 and transmit the waveform with the cyclic prefix as a multilayer transmission 550. A receiving device may receive the multilayer transmission 550 via the M orthogonal resources. As described herein, the transmitting device may indicate the resource mapping vectors s=[s₁, . . . , s_{K}] to the receiving device such that the receiving device can receive and decode the multilayer transmission 550.

To design the resource mapping vectors s, the transmitting device may apply a greedy algorithm for equalizing the multilayer efficiency across the subcarriers. Equation 4 shows a shows a fixed point equation for the asymptotic multilayer efficiency η in terms of receiver SNR for each of K layers (SNRₖ), where Pₖ is the transmit power each layer may allocate across dₖ=d out of M orthogonal resources (e.g., M subcarriers) (same d ∇k), and αₖ is the large scale fading (e.g., pathloss and/or shadowing) per layer k.

$${η}_{f} = η = {[ 1 + {\sum }_{k i n f} {S}_{f k}^{2} \frac{{α}_{k}^{2}}{{P}_{k} {α}_{k}^{2} \cdot η + {σ}^{2}} ]}^{- 1} ∀ f \qquad ( 4 )$$

Equation 5 shows a fixed point equation for the asymptotic ME n in terms of receiver SNR for each of K layers. The transmitting device may apply a greedy algorithm to equalize the ME across subcarriers as in equation 5 when generating the sparse code matrix (e.g., the set of resource mapping vectors s=[s₁, . . . , s_{K}]).

$$η = {[ 1 + \frac{1}{M} {\sum }_{k = 1}^{K} \frac{S N {R}_{k} {α}_{k}^{2}}{S N {R}_{k} {α}_{k}^{2} \cdot η + 1} ]}^{- 1} \qquad ( 5 )$$

Letting

$${δ}_{k} = \frac{{α}_{k}^{2}}{{P}_{k} {α}_{k}^{2} \cdot η + {σ}^{2}} ,$$

then equation 5 becomes η_{f}=η=[1+Σ_{k in f} S_{fk}²δₖ]⁻¹∇f. In a first stage of the greedy algorithm, out of all the layers which have not yet allocated their power into d subcarriers, the transmitting device finds layer k′ for which

$${k}^{′} = arg {max}_{k} \frac{{P}_{k}}{d} {δ}_{k}$$

(e.g., the most ME-influential layer). At a second stage of the greedy algorithm, the transmitting device calculates ρ_{f} as ρ_{f}=Σ_{k in f} S_{fk}²δₖ, and thus η_{f}=[1+ρ_{f}]⁻¹. At a third stage of the greedy algorithm, the transmitting device finds the subcarrier out of the subcarriers that were not already assigned to the layer k′ for which

$${f}^{′} = {arg}_{f} min {ρ}_{f}$$

(adding MAI wo the subcarrier with the maximal ME). At a fourth stage of the greedy algorithm, the transmitting device sets S_{f′k′}=\sqrt{Pₖ/d}. The transmitting device returns to the first stage until all K layers have respective transmission powers allocated into d subcarriers. All layers may exhibit the same large-scale fading (e.g., αₖ=α) and thus the resulting multilayer efficiency equalized design for equal power-layer may be regular (e.g., as a Gallager construction).

As described herein, the greedy algorithm may be run at the transmitting device (e.g., a UE 115 if the multilayer transmission 550 is an uplink transmission or a network entity 105 if the multilayer transmission 550 is a downlink transmission). The set of resource mapping vectors s=[s₁, . . . , s_{K}] may be updated when the relative layer transmission power changes. For equal-power layering, the scheduling may become fully regular.

As an example, the greedy algorithm may be used given K=36, and N=12, then β=3. In the example, Pₖ=30 dBm and σ²=−60 dBm, large scale fading is due to pathloss uniformly distributed in [−140−60] dB, 100 UE drops, and small scale fading is uncorrelated Rayleigh fading at 1000 realizations per UE drop. In such an example, the described greedy algorithm may have a higher spectral efficiency than regular dense mapping, regular sparse mapping (e.g., (d,βd)—Gallager construction), semi-regular mapping where a symbol is transmitted in d randomly selected subcarriers for each layer, irregular mapping where a random quantity of subcarriers are used for each layer and where the total quantity of subcarriers across the layers is drawn from a

$${S}_{f k} = \frac{1}{\sqrt{M}}$$

Poisson distribution with a mean of d, dense mapping with and orthogonal transmissions among the layers. For example, when d=1, the spectral efficiency of the described greedy algorithm may be 101% of regular dense mapping, when d=2, the spectral efficiency of the described greedy algorithm may be 100% of regular dense mapping, and when d=3, the spectral efficiency of the described greedy algorithm may be 100% of regular dense mapping. For the multi-layer case as described herein, the sum capacity gain with respect to semi-regular resource scheduling may be approximately 6% for d=1 and approximately 1% for d=2. Similar to a Gaussian channel, the highest SPEF design may be regular mapping.

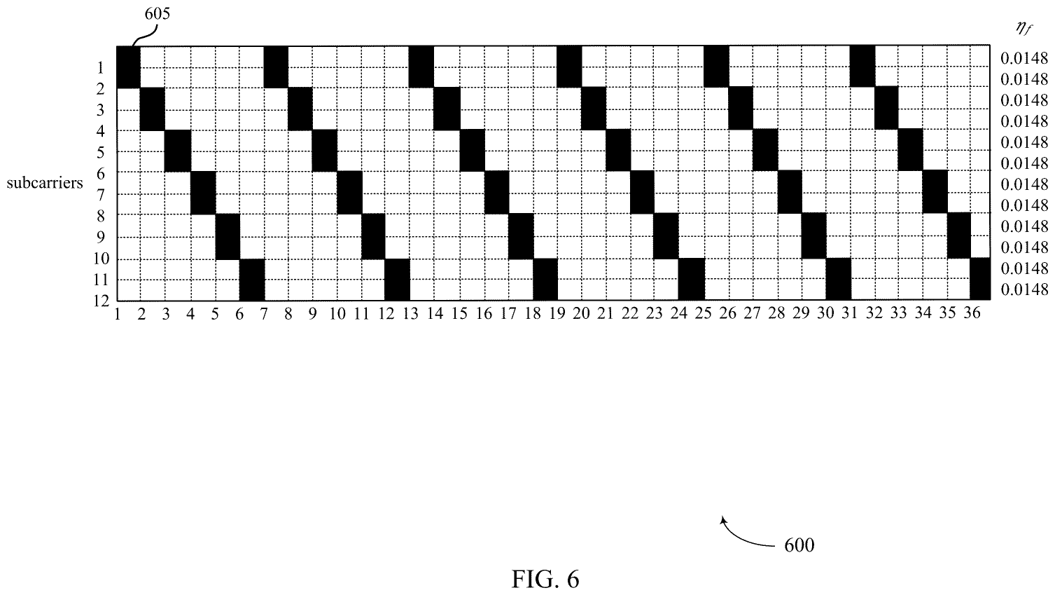

FIG. 6 shows an example of a resource diagram 600 that supports resource scheduling for sparse non-orthogonal transmissions in accordance with one or more aspects of the present disclosure. The resource diagram 600 may implement aspects of or may be implemented by aspects of the wireless communications system 100, the wireless communications system 200, or the transmission scheme 500.

For example, the resource diagram 600 shows an example of assigned resources 605 for 12 subcarriers (M=12 subcarriers) where d=2 subcarriers for K=36 UEs, and the asymptotic η=0.0148. As the SPEF may be invariant to row/column permutations, and as shown multilayer efficiency for the subcarriers η_{f} may be equalized across the subcarriers as all layers may exhibit the same large-scale fading (e.g., αₖ=α).

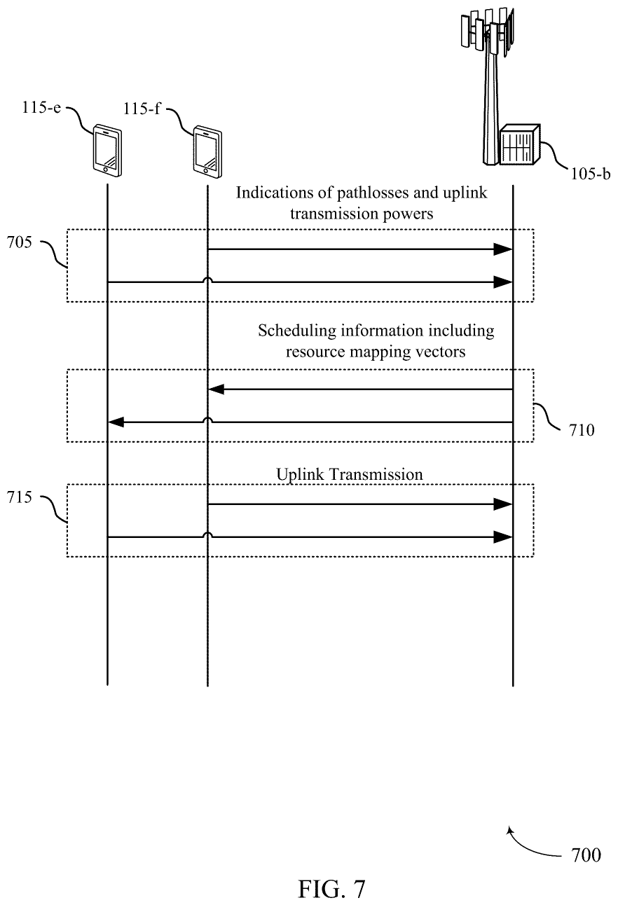

FIG. 7 shows an example of a process flow 700 that supports resource scheduling for sparse non-orthogonal transmissions in accordance with one or more aspects of the present disclosure. The process flow 700 may include a UE 115-e and a UE 115-f, which may be examples of a UE 115 as described herein. The process flow 700 may include a network entity 105-b, which may be an example of a network entity 105 as described herein. In the following description of the process flow 700, the operations between the network entity 105-b, the UE 115-e, and the UE 115-f may be transmitted in a different order than the example order shown, or the operations performed by the network entity 105-b, the UE 115-e, and the UE 115-f may be performed in different orders or at different times. Some operations may also be omitted from the process flow 700, and other operations may be added to the process flow 700.

At 705, the network entity 105-b may receive, from a set of multiple UEs 115 including the UE 115-e and the UE 115-f, indications of respective pathloss values for respective communication channels between the set of multiple UEs and the network entity 105-b and respective uplink powers for the set of multiple of UEs. For example, the UE 115-e may transmit an indication of a pathloss value for the communication channel between the UE 115-e and the network entity 105-b and an uplink power for the UE 115-e, and the UE 115-f may transmit an indication of a pathloss value for the communication channel between the UE 115-f and the network entity 105-b and an uplink power for the UE 115-f. In some examples, the pathloss and uplink power for a given UE 115 may be indicated as a receiver SNR value.

At 710, the network entity 105-b may transmit, to the set of multiple UEs 115 and based on the pathloss value and the uplink power, respective scheduling information for respective uplink communications for the set of multiple UEs 115. The respective scheduling information may include respective resource mapping vectors indicative of respective assigned subsets of orthogonal resources of a set of multiple orthogonal resources and respective repetition codes for the respective uplink communications. For example, the UE 115-e may receive scheduling information for an uplink communication for the UE 115-e, where the scheduling information includes a resource mapping vector indicative of an assigned subset of orthogonal resources of a set of multiple orthogonal resources and a repetition code for the uplink communication for the UE 115-e. Similarly, the UE 115-f may receive scheduling information for an uplink communication for the UE 115-f, where the scheduling information includes a resource mapping vector indicative of an assigned subset of orthogonal resources of a set of multiple orthogonal resources and a repetition code for the uplink communication for the UE 115-f.

At 715, the network entity 105-b may receive, from the set of multiple UEs 115 via the respective assigned subsets of orthogonal resources, the respective uplink communications in accordance with the respective repetition codes. For example, the UE 115-e may transmit, to the network entity 105-b and via the assigned subset of orthogonal resources for the UE 115-e, an uplink communication in accordance with the repetition code indicated to the UE 115-e. Similarly, the UE 115-f may transmit, to the network entity 105-b and via the assigned subset of orthogonal resources for the UE 115-f, an uplink communication in accordance with the repetition code indicated to the UE 115-f.

In some examples, a length of the respective repetition codes is equal to a quantity of orthogonal resources of the set of multiple orthogonal resources.

In some examples, a quantity of UEs 115 of the set of multiple UEs 115 is greater than a quantity of orthogonal resources of the set of multiple orthogonal resources. In some examples, a quantity of orthogonal resources in each of the respective assigned subsets of orthogonal resources is equal.

In some examples, the set of multiple orthogonal resources are a set of multiple frequency resources (e.g. subcarriers) associated with a same time resource. In some examples, the respective assigned subsets of orthogonal resources each include two or more adjacent frequency resources of the set of multiple frequency resources.

In some examples, the network entity 105-b may obtain, from at least one of the set of multiple UEs 115, an update to at least one of the respective pathloss values or the respective uplink powers. For example, the UE 115-e may transmit an update to at least one of the pathloss value or the uplink power subsequent to the transmission at 715. In such examples, the network entity 105-b may transmit, to the set of multiple UEs 115 and based on the update, second respective scheduling information for second respective uplink communications for the set of multiple UEs 115, the second respective scheduling information including second respective resource mapping vectors indicative of second respective assigned subsets of orthogonal resources of the set of multiple orthogonal resources and second respective repetition codes for the second respective uplink communications. The network entity 105-b may receive, from the set of multiple UEs 115 via the second respective assigned subsets of orthogonal resources, the second respective uplink communications in accordance with the second respective repetition codes.

In some examples, the uplink communications may be multilayer uplink transmissions (e.g., multiuser and multilayer NOMA uplink transmission). For example, instead of K UEs 115, there may be K/2 UEs and each UE may use two non-orthogonal transmission layers (e.g., as described with reference to FIGS. 5 and 6). For example, each UE 115 may use the greedy algorithm described herein to assign orthogonal resources to transmission layers. As another example, each of the respective resource mapping vectors may indicate which orthogonal resources of the respective assigned subsets of orthogonal resources are assigned to which of the respective set of multiple transmission layers.

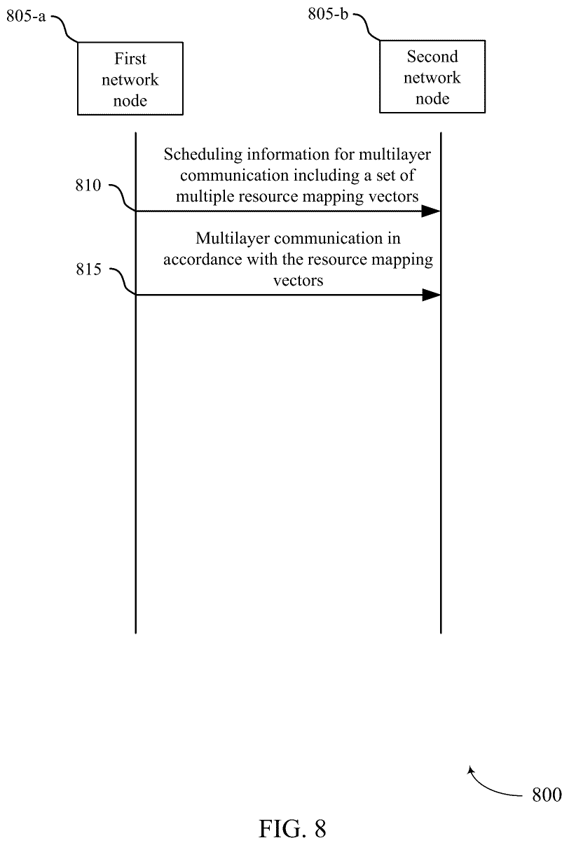

FIG. 8 shows an example of a process flow 800 that supports resource scheduling for sparse non-orthogonal transmissions in accordance with one or more aspects of the present disclosure. The process flow 800 may include a first network node 805-a and a second network node 805-b, which may be examples of UEs 115 or network entities 105 as described herein. In the following description of the process flow 800, the operations between the first network node 805-a and the second network node 805-b may be transmitted in a different order than the example order shown, or the operations performed by the first network node 805-a and the second network node 805-b may be performed in different orders or at different times. Some operations may also be omitted from the process flow 800, and other operations may be added to the process flow 800.

At 810, the first network node 805-a may transmit, to the second network node 805-b, scheduling information for a multilayer communication from the first network node 805-a to the second network node 805-b. The scheduling information may include a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers.

At 815, the first network node 805-a may transmit, to the second network node 805-b, the multilayer communication via the respective assigned subsets of orthogonal resources and in accordance with the respective repetition codes for each respective transmission layer.

In some examples, a length of each of the respective repetition codes is equal to a quantity of orthogonal resources of the set of multiple orthogonal resources.

In some examples, a quantity of layers of the respective set of multiple transmission layers is greater than a quantity of orthogonal resources of the set of multiple orthogonal resources.

In some examples, a quantity of orthogonal resources in each of the respective assigned subsets of orthogonal resources is equal.

In some examples, the set of multiple orthogonal resources are a set of multiple frequency resources associated with a same time resource. In some examples, each of the respective assigned subsets of orthogonal resources include two or more adjacent frequency resources of the set of multiple frequency resources.

In some examples, the multilayer communication is an uplink communication (e.g., the first network node 805-a is a UE 115 and the second network node 805-b is a network entity 105). In some examples, the multilayer communication is a downlink communication (e.g., the first network node 805-a is a network entity 105 and the second network node 805-b is a UE 115).

In some examples, the first network node 805-a may identify respective pathloss values for respective communication channels between the first network node and the second network node for the respective set of multiple transmission layer, and/or the first network node 805-a may identify respective transmission powers for the respective set of multiple transmission layers, and the set of multiple resource mapping vectors may be based on the respective pathloss values and/or the respective transmission powers. In some examples, the respective pathloss values for the respective communication channels may all be equal, and thus the resource mapping vectors may be based on the respective transmission powers. In some examples, the first network node 805-a may identify an update to at least one of the respective pathloss values or the respective transmission powers. In such examples, the first network node 805-a may transmit, to the second network node 805-b, second scheduling information for a second multilayer communication from the first network node 805-a to the second network node 805-b, where the second scheduling information includes a second set of multiple resource mapping vectors for the respective set of multiple transmission layers for the multilayer communication, where the second set of multiple resource mapping vectors are indicative of respective second assigned subsets of orthogonal resources of the set of multiple orthogonal resources and respective second repetition codes for the second multilayer communication for the respective transmission layers of the respective set of multiple transmission layers, and where the second set of multiple resource mapping vectors are based on the update. The first network node 805-a may transmit, to the second network node 805-b, the second multilayer communication via the respective second assigned subsets of orthogonal resources and in accordance with the respective second repetition codes for each respective transmission layer.

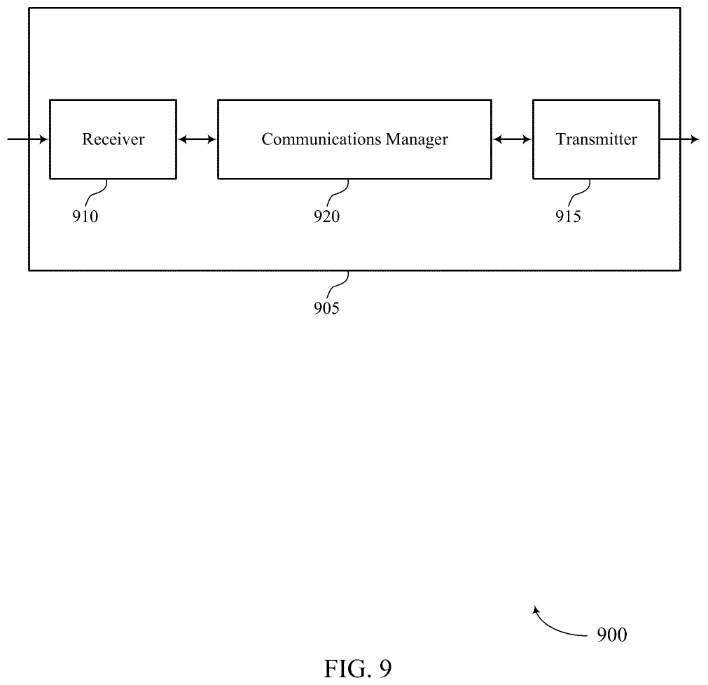

FIG. 9 shows a block diagram 900 of a device 905 that supports resource scheduling for sparse non-orthogonal transmissions in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor (not shown), which may be coupled with at least one memory (not shown), to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to resource scheduling for sparse non-orthogonal transmissions). Information may be passed on to other components of the device 905. The receiver 910 may utilize a single antenna (not shown) or a set of multiple antennas (not shown).

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to resource scheduling for sparse non-orthogonal transmissions). In some examples, the transmitter 915 may be co-located with a receiver 910 in a transceiver module. The transmitter 915 may utilize a single antenna (not shown) or a set of multiple antennas (not shown).

The communications manager 920, the receiver 910, the transmitter 915, or various combinations thereof or various components thereof may be examples of means for performing various aspects of resource scheduling for sparse non-orthogonal transmissions as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a network entity, an indication of a pathloss value for a communication channel between the UE and the network entity and an uplink power for the UE. The communications manager 920 is capable of, configured to, or operable to support a means for receiving, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication. The communications manager 920 is capable of, configured to, or operable to support a means for transmitting, to the network entity and via the assigned subset of orthogonal resources, the uplink communication in accordance with the repetition code.

Additionally, or alternatively, the communications manager 920 may support wireless communications in accordance with examples as disclosed herein. For example, the communications manager 920 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 920 is capable of, configured to, or operable to support a means for outputting, to the second network node, the multilayer communication via the respective assigned subsets of orthogonal resources and in accordance with the respective repetition codes for each respective transmission layer.

Additionally, or alternatively, the communications manager 920 may support wireless communications in accordance with examples as disclosed herein. For example, the communications manager 920 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 920 is capable of, configured to, or operable to support a means for obtaining, from the first network node, the multilayer communication via the respective assigned subsets of orthogonal resources and in accordance with the respective repetition codes for each respective transmission layer.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

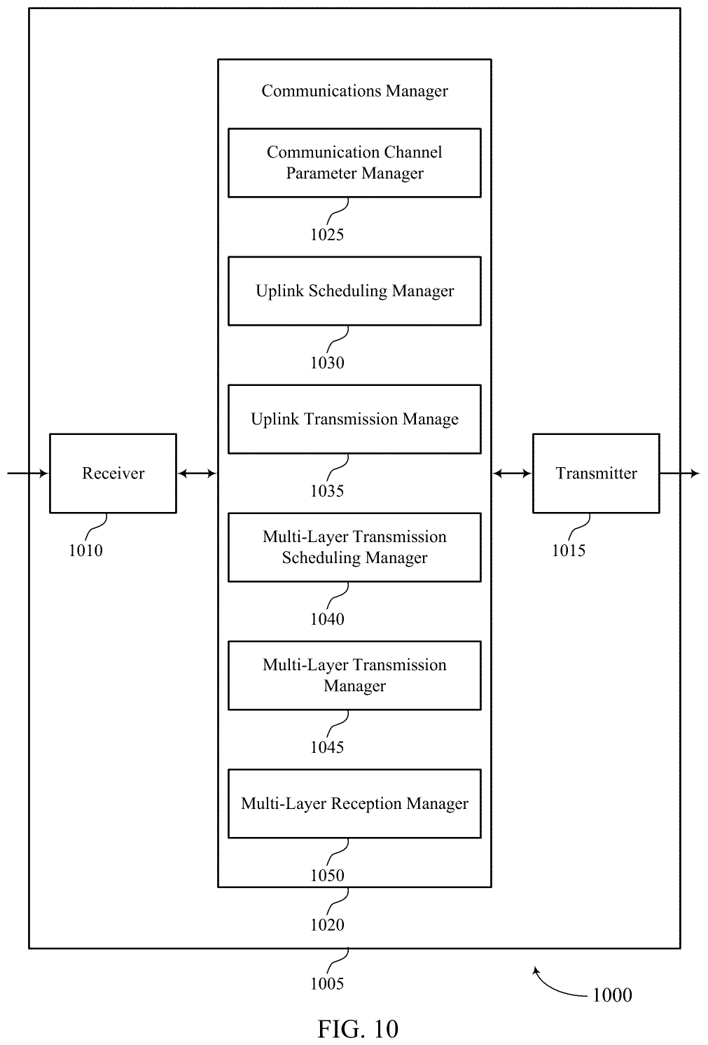

FIG. 10 shows a block diagram 1000 of a device 1005 that supports resource scheduling for sparse non-orthogonal transmissions in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor (not shown), which may be coupled with at least one memory (not shown), to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to resource scheduling for sparse non-orthogonal transmissions). Information may be passed on to other components of the device 1005. The receiver 1010 may utilize a single antenna (not shown) or a set of multiple antennas (not shown).

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to resource scheduling for sparse non-orthogonal transmissions). In some examples, the transmitter 1015 may be co-located with a receiver 1010 in a transceiver module. The transmitter 1015 may utilize a single antenna (not shown) or a set of multiple antennas (not shown).

The device 1005, or various components thereof, may be an example of means for performing various aspects of resource scheduling for sparse non-orthogonal transmissions as described herein. For example, the communications manager 1020 may include a communication channel parameter manager 1025, an uplink scheduling manager 1030, an uplink transmission manage 1035, a multi-layer transmission scheduling manager 1040, a multi-layer transmission manager 1045, a multi-layer reception manager 1050, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The communication channel parameter manager 1025 is capable of, configured to, or operable to support a means for transmitting, to a network entity, an indication of a pathloss value for a communication channel between the UE and the network entity and an uplink power for the UE. The uplink scheduling manager 1030 is capable of, configured to, or operable to support a means for receiving, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication. The uplink transmission manage 1035 is capable of, configured to, or operable to support a means for transmitting, to the network entity and via the assigned subset of orthogonal resources, the uplink communication in accordance with the repetition code.

Additionally, or alternatively, the communications manager 1020 may support wireless communications in accordance with examples as disclosed herein. The multi-layer transmission scheduling manager 1040 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer transmission manager 1045 is capable of, configured to, or operable to support a means for outputting, to the second network node, the multilayer communication via the respective assigned subsets of orthogonal resources and in accordance with the respective repetition codes for each respective transmission layer.

Additionally, or alternatively, the communications manager 1020 may support wireless communications in accordance with examples as disclosed herein. The multi-layer transmission scheduling manager 1040 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer reception manager 1050 is capable of, configured to, or operable to support a means for obtaining, from the first network node, the multilayer communication via the respective assigned subsets of orthogonal resources and in accordance with the respective repetition codes for each respective transmission layer.

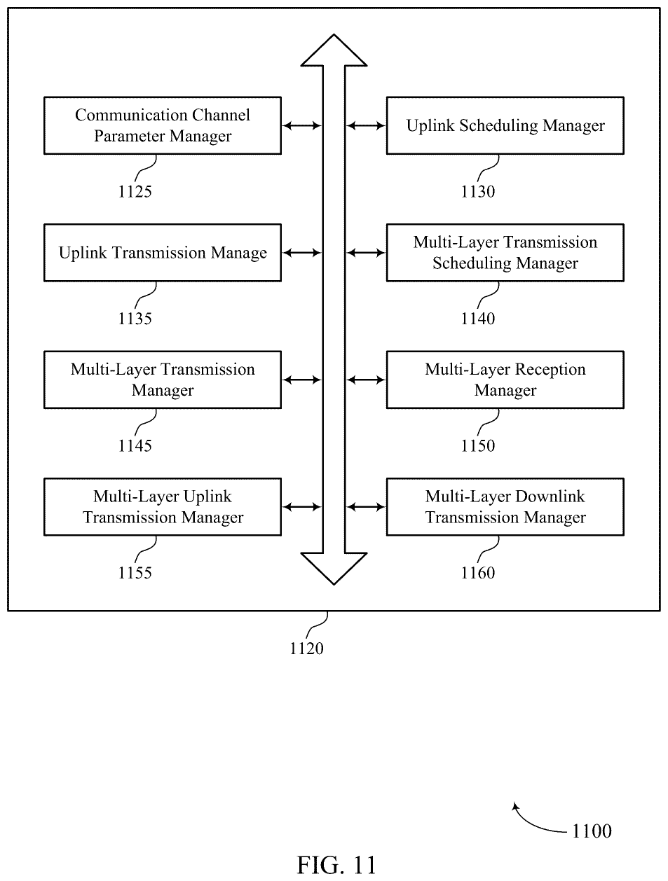

FIG. 11 shows a block diagram 1100 of a communications manager 1120 that supports resource scheduling for sparse non-orthogonal transmissions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of resource scheduling for sparse non-orthogonal transmissions as described herein. For example, the communications manager 1120 may include a communication channel parameter manager 1125, an uplink scheduling manager 1130, an uplink transmission manage 1135, a multi-layer transmission scheduling manager 1140, a multi-layer transmission manager 1145, a multi-layer reception manager 1150, a multi-layer uplink transmission manager 1155, a multi-layer downlink transmission manager 1160, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The communication channel parameter manager 1125 is capable of, configured to, or operable to support a means for transmitting, to a network entity, an indication of a pathloss value for a communication channel between the UE and the network entity and an uplink power for the UE. The uplink scheduling manager 1130 is capable of, configured to, or operable to support a means for receiving, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication. The uplink transmission manage 1135 is capable of, configured to, or operable to support a means for transmitting, to the network entity and via the assigned subset of orthogonal resources, the uplink communication in accordance with the repetition code.

In some examples, the communication channel parameter manager 1125 is capable of, configured to, or operable to support a means for transmitting, to the network entity and subsequent to transmission of the uplink communication, an update to at least one of the pathloss value or the uplink power. In some examples, the uplink scheduling manager 1130 is capable of, configured to, or operable to support a means for receiving, from the network entity and based on the update, second scheduling information for a second uplink communication, where the second scheduling information includes a second resource mapping vector indicative of a second assigned subset of orthogonal resources of the set of multiple orthogonal resources and a second repetition code for the second uplink communication. In some examples, the uplink transmission manage 1135 is capable of, configured to, or operable to support a means for transmitting, to the network entity and via the second assigned subset of orthogonal resources, the second uplink communication in accordance with the repetition code.

In some examples, a length of the repetition code is equal to a quantity of orthogonal resources of the set of multiple orthogonal resources.

In some examples, the set of multiple orthogonal resources are shared for a set of multiple UEs. In some examples, the set of multiple UEs includes the UE.

In some examples, a quantity of UEs of the set of multiple UEs is greater than a quantity of orthogonal resources of the set of multiple orthogonal resources.

In some examples, a quantity of assigned orthogonal resources for each of the set of multiple UEs is equal.

In some examples, the set of multiple orthogonal resources are a set of multiple frequency resources associated with a same time resource.

In some examples, the assigned subset of orthogonal resources include two or more adjacent frequency resources of the set of multiple frequency resources.

In some examples, to support transmitting the uplink communication, the multi-layer transmission manager 1145 is capable of, configured to, or operable to support a means for transmitting the uplink communication via a set of multiple transmission layers, where the resource mapping vector indicates which orthogonal resource of the assigned subset of orthogonal resources are assigned to which of the set of multiple transmission layers.

Additionally, or alternatively, the communications manager 1120 may support wireless communications in accordance with examples as disclosed herein. The multi-layer transmission scheduling manager 1140 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer transmission manager 1145 is capable of, configured to, or operable to support a means for outputting, to the second network node, the multilayer communication via the respective assigned subsets of orthogonal resources and in accordance with the respective repetition codes for each respective transmission layer.

In some examples, the communication channel parameter manager 1125 is capable of, configured to, or operable to support a means for identifying respective pathloss values for respective communication channels between the first network node and the second network node for the respective set of multiple transmission layers. In some examples, the communication channel parameter manager 1125 is capable of, configured to, or operable to support a means for identifying respective transmission powers for the respective set of multiple transmission layers, where the set of multiple resource mapping vectors are based on the respective pathloss values and the respective transmission powers.

In some examples, the communication channel parameter manager 1125 is capable of, configured to, or operable to support a means for identifying an update to at least one of the respective pathloss values or the respective transmission powers. In some examples, the multi-layer transmission scheduling manager 1140 is capable of, configured to, or operable to support a means for outputting, to the second network node, second scheduling information for a second multilayer communication from the first network node to the second network node, the second scheduling information including a second set of multiple resource mapping vectors for the respective set of multiple transmission layers for the multilayer communication, where the second set of multiple resource mapping vectors are indicative of respective second assigned subsets of orthogonal resources of the set of multiple orthogonal resources and respective second repetition codes for the second multilayer communication for the respective transmission layers of the respective set of multiple transmission layers, where the second set of multiple resource mapping vectors are based on the update. In some examples, the multi-layer transmission manager 1145 is capable of, configured to, or operable to support a means for outputting, to the second network node, the second multilayer communication via the respective second assigned subsets of orthogonal resources and in accordance with the respective second repetition codes for each respective transmission layer.

In some examples, a length of each of the respective repetition codes is equal to a quantity of orthogonal resources of the set of multiple orthogonal resources.

In some examples, a quantity of layers of the respective set of multiple transmission layers is greater than a quantity of orthogonal resources of the set of multiple orthogonal resources.

In some examples, a quantity of orthogonal resources in each of the respective assigned subsets of orthogonal resources is equal.

In some examples, the set of multiple orthogonal resources are a set of multiple frequency resources associated with a same time resource.

In some examples, each of the respective assigned subsets of orthogonal resources include two or more adjacent frequency resources of the set of multiple frequency resources.

In some examples, to support outputting the multilayer communication, the multi-layer uplink transmission manager 1155 is capable of, configured to, or operable to support a means for outputting an uplink communication to a network entity, where the first network node is a UE, and where the second network node is the network entity.

In some examples, to support outputting the multilayer communication, the multi-layer downlink transmission manager 1160 is capable of, configured to, or operable to support a means for outputting a downlink communication to a UE, where the first network node is a network entity, and where the second network node is the UE.

Additionally, or alternatively, the communications manager 1120 may support wireless communications in accordance with examples as disclosed herein. In some examples, the multi-layer transmission scheduling manager 1140 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer reception manager 1150 is capable of, configured to, or operable to support a means for obtaining, from the first network node, the multilayer communication via the respective assigned subsets of orthogonal resources and in accordance with the respective repetition codes for each respective transmission layer.

In some examples, the set of multiple resource mapping vectors are based on respective pathloss values for respective communication channels between the first network node and the second network node for the respective set of multiple transmission layers and respective transmission powers for the respective set of multiple transmission layers.

In some examples, the multi-layer transmission scheduling manager 1140 is capable of, configured to, or operable to support a means for obtaining, from the first network node and based on an update to at least one of the respective pathloss values or the respective transmission powers, second scheduling information for a second multilayer communication from the first network node to the second network node, the second scheduling information including a second set of multiple resource mapping vectors for the respective set of multiple transmission layers for the multilayer communication, where the second set of multiple resource mapping vectors are indicative of respective second assigned subsets of orthogonal resources of the set of multiple orthogonal resources and respective second repetition codes for the second multilayer communication for the respective transmission layers of the respective set of multiple transmission layers, where the second set of multiple resource mapping vectors are based on the update. In some examples, the multi-layer reception manager 1150 is capable of, configured to, or operable to support a means for obtaining, from the first network node, the second multilayer communication via the respective second assigned subsets of orthogonal resources and in accordance with the respective second repetition codes for each respective transmission layer.

In some examples, a length of each of the respective repetition codes is equal to a quantity of orthogonal resources of the set of multiple orthogonal resources.

In some examples, a quantity of layers of the respective set of multiple transmission layers is greater than a quantity of orthogonal resources of the set of multiple orthogonal resources.

In some examples, a quantity of orthogonal resources in each of the respective assigned subsets of orthogonal resources is equal.

In some examples, the set of multiple orthogonal resources are a set of multiple frequency resources associated with a same time resource.

In some examples, each of the respective assigned subsets of orthogonal resources include two or more adjacent frequency resources of the set of multiple frequency resources.

In some examples, to support obtaining the multilayer communication, the multi-layer uplink transmission manager 1155 is capable of, configured to, or operable to support a means for obtaining an uplink communication from a UE, where the first network node is the UE, and where the second network node is a network entity.

In some examples, to support obtaining the multilayer communication, the multi-layer downlink transmission manager 1160 is capable of, configured to, or operable to support a means for obtaining a downlink communication from a network entity, where the first network node is the network entity, and where the second network node is a UE.

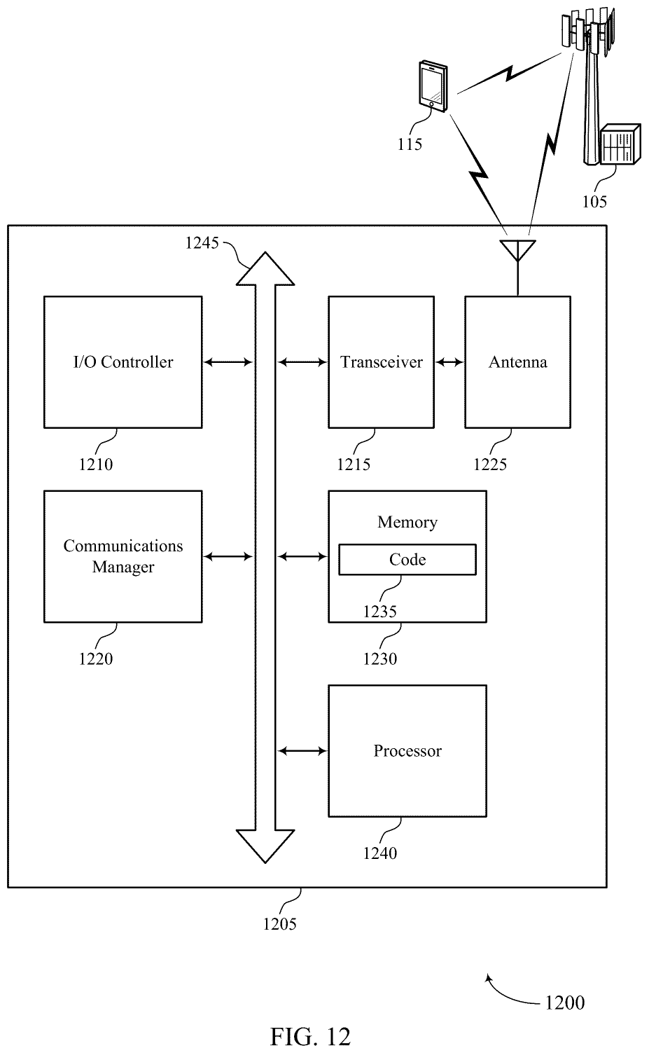

FIG. 12 shows a diagram of a system 1200 including a device 1205 that supports resource scheduling for sparse non-orthogonal transmissions in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting resource scheduling for sparse non-orthogonal transmissions). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. As such, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting, to a network entity, an indication of a pathloss value for a communication channel between the UE and the network entity and an uplink power for the UE. The communications manager 1220 is capable of, configured to, or operable to support a means for receiving, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication. The communications manager 1220 is capable of, configured to, or operable to support a means for transmitting, to the network entity and via the assigned subset of orthogonal resources, the uplink communication in accordance with the repetition code.

Additionally, or alternatively, the communications manager 1220 may support wireless communications in accordance with examples as disclosed herein. For example, the communications manager 1220 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 1220 is capable of, configured to, or operable to support a means for outputting, to the second network node, the multilayer communication via the respective assigned subsets of orthogonal resources and in accordance with the respective repetition codes for each respective transmission layer.

Additionally, or alternatively, the communications manager 1220 may support wireless communications in accordance with examples as disclosed herein. For example, the communications manager 1220 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 1220 is capable of, configured to, or operable to support a means for obtaining, from the first network node, the multilayer communication via the respective assigned subsets of orthogonal resources and in accordance with the respective repetition codes for each respective transmission layer.

By including or configuring the communications manager 1220 in accordance with examples as described herein, the device 1205 may support techniques for improved communication reliability, reduced latency, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of resource scheduling for sparse non-orthogonal transmissions as described herein, or the at least one processor 1240 and the at least one memory 1230 may be otherwise configured to, individually or collectively, perform or support such operations.

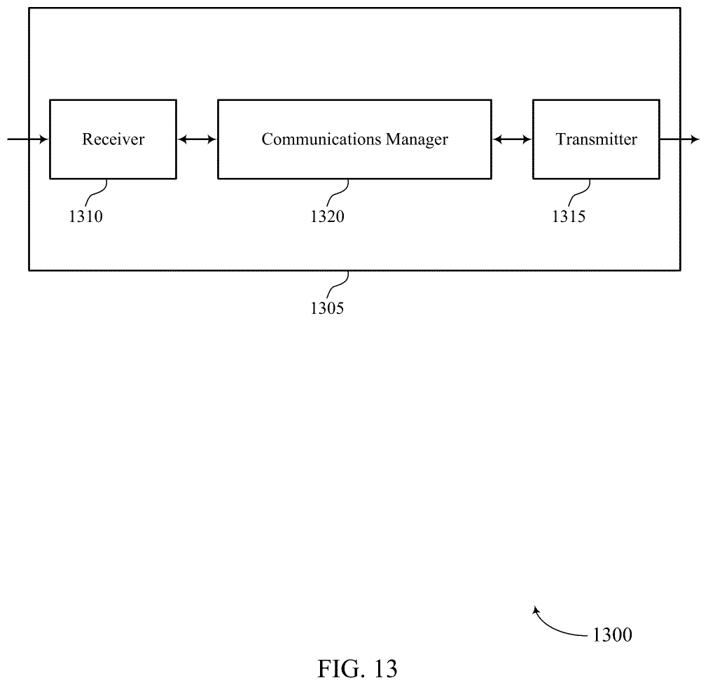

FIG. 13 shows a block diagram 1300 of a device 1305 that supports resource scheduling for sparse non-orthogonal transmissions in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor (not shown), which may be coupled with at least one memory (not shown), to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas (not shown). Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas (not shown). Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of resource scheduling for sparse non-orthogonal transmissions as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor. If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for obtaining, from a set of multiple user equipments (UEs), indications of respective pathloss values for respective communication channels between the set of multiple UEs and the network entity and respective uplink powers for the set of multiple UEs. The communications manager 1320 is capable of, configured to, or operable to support a means for outputting, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications. The communications manager 1320 is capable of, configured to, or operable to support a means for obtaining, from the set of multiple UEs via the respective assigned subsets of orthogonal resources, the respective uplink communications in accordance with the respective repetition codes.

Additionally, or alternatively, the communications manager 1320 may support wireless communications in accordance with examples as disclosed herein. For example, the communications manager 1320 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 1320 is capable of, configured to, or operable to support a means for outputting, to the second network node, the multilayer communication via the respective assigned subsets of orthogonal resources and in accordance with the respective repetition codes for each respective transmission layer.

Additionally, or alternatively, the communications manager 1320 may support wireless communications in accordance with examples as disclosed herein. For example, the communications manager 1320 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 1320 is capable of, configured to, or operable to support a means for obtaining, from the first network node, the multilayer communication via the respective assigned subsets of orthogonal resources and in accordance with the respective repetition codes for each respective transmission layer.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for more efficient utilization of communication resources.

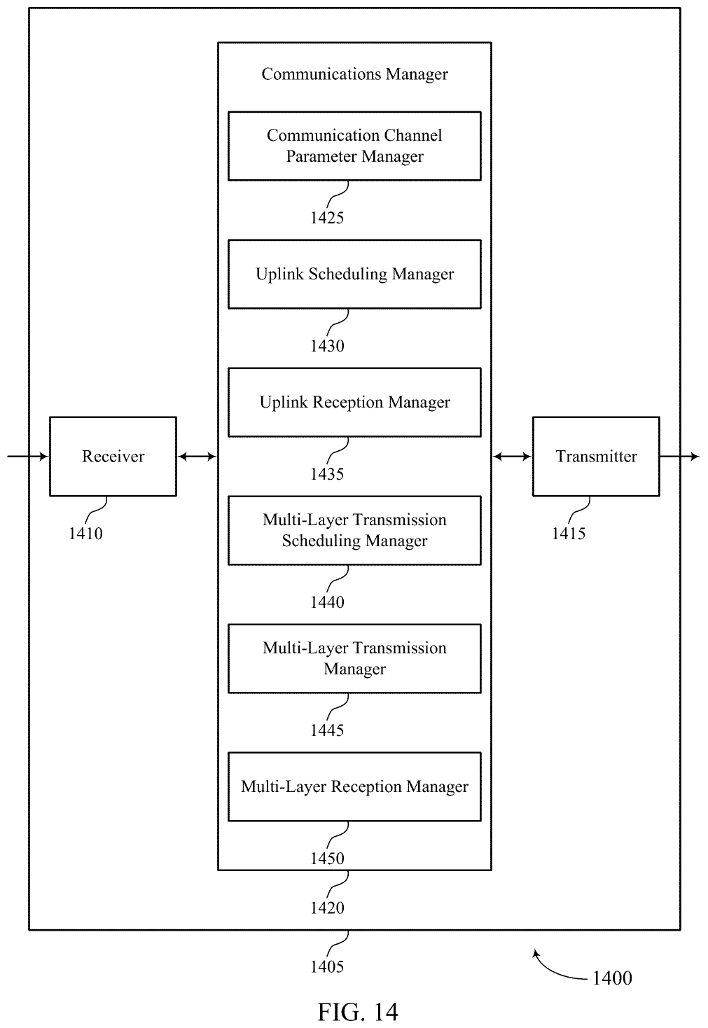

FIG. 14 shows a block diagram 1400 of a device 1405 that supports resource scheduling for sparse non-orthogonal transmissions in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor (not shown), which may be coupled with at least one memory (not shown), to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas (not shown). Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas (not shown). Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of resource scheduling for sparse non-orthogonal transmissions as described herein. For example, the communications manager 1420 may include a communication channel parameter manager 1425, an uplink scheduling manager 1430, an uplink reception manager 1435, a multi-layer transmission scheduling manager 1440, a multi-layer transmission manager 1445, a multi-layer reception manager 1450, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The communication channel parameter manager 1425 is capable of, configured to, or operable to support a means for obtaining, from a set of multiple user equipments (UEs), indications of respective pathloss values for respective communication channels between the set of multiple UEs and the network entity and respective uplink powers for the set of multiple UEs. The uplink scheduling manager 1430 is capable of, configured to, or operable to support a means for outputting, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications. The uplink reception manager 1435 is capable of, configured to, or operable to support a means for obtaining, from the set of multiple UEs via the respective assigned subsets of orthogonal resources, the respective uplink communications in accordance with the respective repetition codes.

Additionally, or alternatively, the communications manager 1420 may support wireless communications in accordance with examples as disclosed herein. The multi-layer transmission scheduling manager 1440 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer transmission manager 1445 is capable of, configured to, or operable to support a means for outputting, to the second network node, the multilayer communication via the respective assigned subsets of orthogonal resources and in accordance with the respective repetition codes for each respective transmission layer.

Additionally, or alternatively, the communications manager 1420 may support wireless communications in accordance with examples as disclosed herein. The multi-layer transmission scheduling manager 1440 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer reception manager 1450 is capable of, configured to, or operable to support a means for obtaining, from the first network node, the multilayer communication via the respective assigned subsets of orthogonal resources and in accordance with the respective repetition codes for each respective transmission layer.

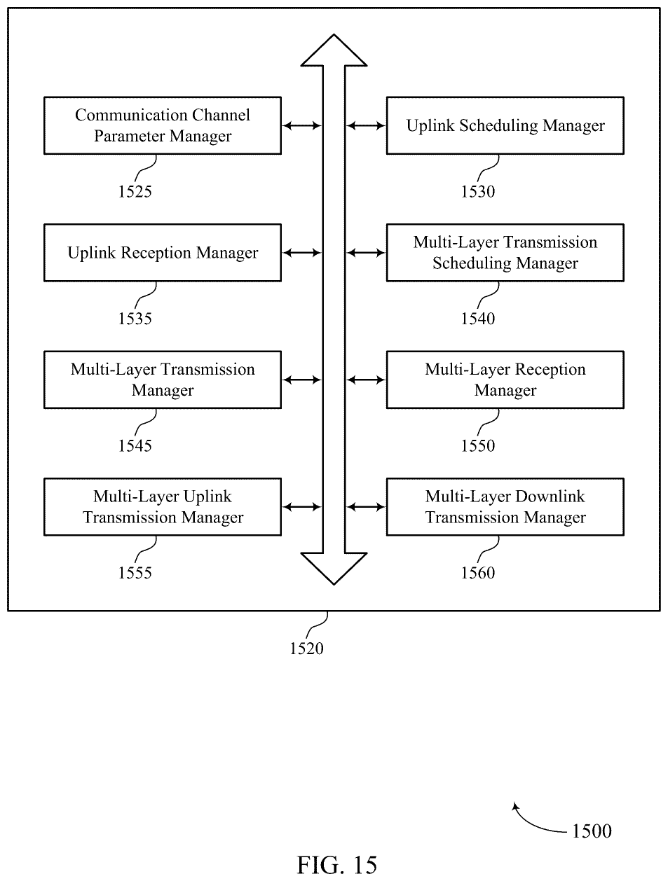

FIG. 15 shows a block diagram 1500 of a communications manager 1520 that supports resource scheduling for sparse non-orthogonal transmissions in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of resource scheduling for sparse non-orthogonal transmissions as described herein. For example, the communications manager 1520 may include a communication channel parameter manager 1525, an uplink scheduling manager 1530, an uplink reception manager 1535, a multi-layer transmission scheduling manager 1540, a multi-layer transmission manager 1545, a multi-layer reception manager 1550, a multi-layer uplink transmission manager 1555, a multi-layer downlink transmission manager 1560, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The communication channel parameter manager 1525 is capable of, configured to, or operable to support a means for obtaining, from a set of multiple user equipments (UEs), indications of respective pathloss values for respective communication channels between the set of multiple UEs and the network entity and respective uplink powers for the set of multiple UEs. The uplink scheduling manager 1530 is capable of, configured to, or operable to support a means for outputting, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications. The uplink reception manager 1535 is capable of, configured to, or operable to support a means for obtaining, from the set of multiple UEs via the respective assigned subsets of orthogonal resources, the respective uplink communications in accordance with the respective repetition codes.

In some examples, the communication channel parameter manager 1525 is capable of, configured to, or operable to support a means for obtaining, from at least one of the set of multiple UEs, an update to at least one of the respective pathloss values or the respective uplink powers. In some examples, the uplink scheduling manager 1530 is capable of, configured to, or operable to support a means for outputting, to the set of multiple UEs and based on the update, second respective scheduling information for second respective uplink communications for the set of multiple UEs, the second respective scheduling information including second respective resource mapping vectors indicative of second respective assigned subsets of orthogonal resources of the set of multiple orthogonal resources and second respective repetition codes for the second respective uplink communications. In some examples, the uplink reception manager 1535 is capable of, configured to, or operable to support a means for obtaining, from the set of multiple UEs via the second respective assigned subsets of orthogonal resources, the second respective uplink communications in accordance with the second respective repetition codes.

In some examples, a length of the respective repetition codes is equal to a quantity of orthogonal resources of the set of multiple orthogonal resources.

In some examples, a quantity of UEs of the set of multiple UEs is greater than a quantity of orthogonal resources of the set of multiple orthogonal resources.

In some examples, a quantity of orthogonal resources in each of the respective assigned subsets of orthogonal resources is equal.

In some examples, the set of multiple orthogonal resources are a set of multiple frequency resources associated with a same time resource.

In some examples, the respective assigned subsets of orthogonal resources each include two or more adjacent frequency resources of the set of multiple frequency resources.

In some examples, to support obtaining the respective uplink communications, the multi-layer transmission manager 1545 is capable of, configured to, or operable to support a means for obtaining each of the respective uplink communications via a respective set of multiple transmission layers, where each of the respective resource mapping vectors indicates which orthogonal resources of the respective assigned subsets of orthogonal resources are assigned to which of the respective set of multiple transmission layers.

Additionally, or alternatively, the communications manager 1520 may support wireless communications in accordance with examples as disclosed herein. The multi-layer transmission scheduling manager 1540 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer transmission manager 1545 is capable of, configured to, or operable to support a means for outputting, to the second network node, the multilayer communication via the respective assigned subsets of orthogonal resources and in accordance with the respective repetition codes for each respective transmission layer.

In some examples, the communication channel parameter manager 1525 is capable of, configured to, or operable to support a means for identifying respective pathloss values for respective communication channels between the first network node and the second network node for the respective set of multiple transmission layers. In some examples, the communication channel parameter manager 1525 is capable of, configured to, or operable to support a means for identifying respective transmission powers for the respective set of multiple transmission layers, where the set of multiple resource mapping vectors are based on the respective pathloss values and the respective transmission powers.

In some examples, the communication channel parameter manager 1525 is capable of, configured to, or operable to support a means for identifying an update to at least one of the respective pathloss values or the respective transmission powers. In some examples, the multi-layer transmission scheduling manager 1540 is capable of, configured to, or operable to support a means for outputting, to the second network node, second scheduling information for a second multilayer communication from the first network node to the second network node, the second scheduling information including a second set of multiple resource mapping vectors for the respective set of multiple transmission layers for the multilayer communication, where the second set of multiple resource mapping vectors are indicative of respective second assigned subsets of orthogonal resources of the set of multiple orthogonal resources and respective second repetition codes for the second multilayer communication for the respective transmission layers of the respective set of multiple transmission layers, where the second set of multiple resource mapping vectors are based on the update. In some examples, the multi-layer transmission manager 1545 is capable of, configured to, or operable to support a means for outputting, to the second network node, the second multilayer communication via the respective second assigned subsets of orthogonal resources and in accordance with the respective second repetition codes for each respective transmission layer.

In some examples, a length of each of the respective repetition codes is equal to a quantity of orthogonal resources of the set of multiple orthogonal resources.

In some examples, a quantity of layers of the respective set of multiple transmission layers is greater than a quantity of orthogonal resources of the set of multiple orthogonal resources.

In some examples, a quantity of orthogonal resources in each of the respective assigned subsets of orthogonal resources is equal.

In some examples, the set of multiple orthogonal resources are a set of multiple frequency resources associated with a same time resource.

In some examples, each of the respective assigned subsets of orthogonal resources include two or more adjacent frequency resources of the set of multiple frequency resources.

In some examples, to support outputting the multilayer communication, the multi-layer uplink transmission manager 1555 is capable of, configured to, or operable to support a means for outputting an uplink communication to a network entity, where the first network node is a UE, and where the second network node is the network entity.

In some examples, to support outputting the multilayer communication, the multi-layer downlink transmission manager 1560 is capable of, configured to, or operable to support a means for outputting a downlink communication to a UE, where the first network node is a network entity, and where the second network node is the UE.

Additionally, or alternatively, the communications manager 1520 may support wireless communications in accordance with examples as disclosed herein. In some examples, the multi-layer transmission scheduling manager 1540 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The multi-layer reception manager 1550 is capable of, configured to, or operable to support a means for obtaining, from the first network node, the multilayer communication via the respective assigned subsets of orthogonal resources and in accordance with the respective repetition codes for each respective transmission layer.

In some examples, the set of multiple resource mapping vectors are based on respective pathloss values for respective communication channels between the first network node and the second network node for the respective set of multiple transmission layers and respective transmission powers for the respective set of multiple transmission layers.

In some examples, the multi-layer transmission scheduling manager 1540 is capable of, configured to, or operable to support a means for obtaining, from the first network node and based on an update to at least one of the respective pathloss values or the respective transmission powers, second scheduling information for a second multilayer communication from the first network node to the second network node, the second scheduling information including a second set of multiple resource mapping vectors for the respective set of multiple transmission layers for the multilayer communication, where the second set of multiple resource mapping vectors are indicative of respective second assigned subsets of orthogonal resources of the set of multiple orthogonal resources and respective second repetition codes for the second multilayer communication for the respective transmission layers of the respective set of multiple transmission layers, where the second set of multiple resource mapping vectors are based on the update. In some examples, the multi-layer reception manager 1550 is capable of, configured to, or operable to support a means for obtaining, from the first network node, the second multilayer communication via the respective second assigned subsets of orthogonal resources and in accordance with the respective second repetition codes for each respective transmission layer.

In some examples, a length of each of the respective repetition codes is equal to a quantity of orthogonal resources of the set of multiple orthogonal resources.

In some examples, a quantity of layers of the respective set of multiple transmission layers is greater than a quantity of orthogonal resources of the set of multiple orthogonal resources.

In some examples, a quantity of orthogonal resources in each of the respective assigned subsets of orthogonal resources is equal.

In some examples, the set of multiple orthogonal resources are a set of multiple frequency resources associated with a same time resource.

In some examples, each of the respective assigned subsets of orthogonal resources include two or more adjacent frequency resources of the set of multiple frequency resources.

In some examples, to support obtaining the multilayer communication, the multi-layer uplink transmission manager 1555 is capable of, configured to, or operable to support a means for obtaining an uplink communication from a UE, where the first network node is the UE, and where the second network node is a network entity.

In some examples, to support obtaining the multilayer communication, the multi-layer downlink transmission manager 1560 is capable of, configured to, or operable to support a means for obtaining a downlink communication from a network entity, where the first network node is the network entity, and where the second network node is a UE.

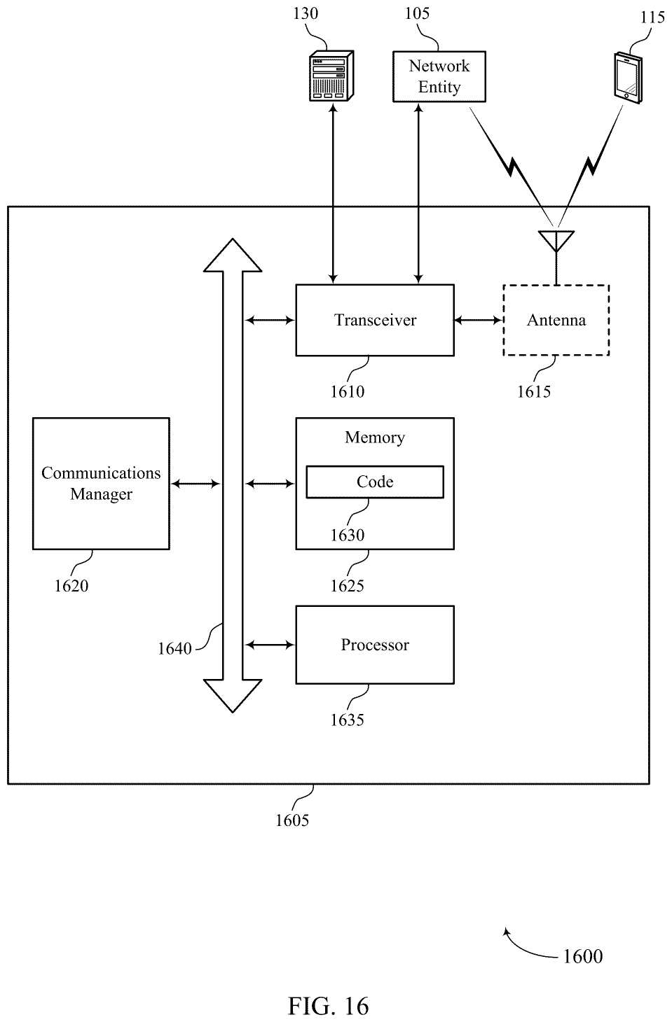

FIG. 16 shows a diagram of a system 1600 including a device 1605 that supports resource scheduling for sparse non-orthogonal transmissions in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., a communication link 125, a backhaul communication link 120, a midhaul communication link 162, a fronthaul communication link 168).

The at least one memory 1625 may include RAM, ROM, or any combination thereof. The at least one memory 1625 may store computer-readable, computer-executable code 1630 including instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may contain, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting resource scheduling for sparse non-orthogonal transmissions). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. As such, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for obtaining, from a set of multiple user equipments (UEs), indications of respective pathloss values for respective communication channels between the set of multiple UEs and the network entity and respective uplink powers for the set of multiple UEs. The communications manager 1620 is capable of, configured to, or operable to support a means for outputting, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications. The communications manager 1620 is capable of, configured to, or operable to support a means for obtaining, from the set of multiple UEs via the respective assigned subsets of orthogonal resources, the respective uplink communications in accordance with the respective repetition codes.

Additionally, or alternatively, the communications manager 1620 may support wireless communications in accordance with examples as disclosed herein. For example, the communications manager 1620 is capable of, configured to, or operable to support a means for outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 1620 is capable of, configured to, or operable to support a means for outputting, to the second network node, the multilayer communication via the respective assigned subsets of orthogonal resources and in accordance with the respective repetition codes for each respective transmission layer.

Additionally, or alternatively, the communications manager 1620 may support wireless communications in accordance with examples as disclosed herein. For example, the communications manager 1620 is capable of, configured to, or operable to support a means for obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The communications manager 1620 is capable of, configured to, or operable to support a means for obtaining, from the first network node, the multilayer communication via the respective assigned subsets of orthogonal resources and in accordance with the respective repetition codes for each respective transmission layer.

By including or configuring the communications manager 1620 in accordance with examples as described herein, the device 1605 may support techniques for improved communication reliability, reduced latency, more efficient utilization of communication resources, and improved coordination between devices.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of resource scheduling for sparse non-orthogonal transmissions as described herein, or the at least one processor 1635 and the at least one memory 1625 may be otherwise configured to, individually or collectively, perform or support such operations.

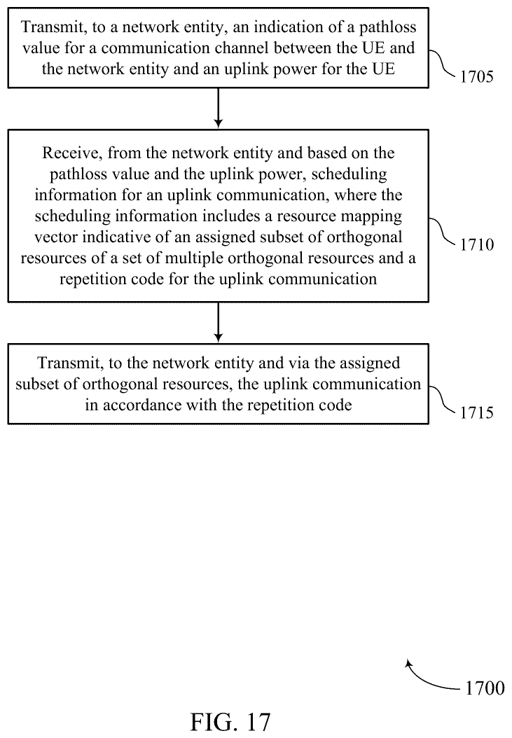

FIG. 17 shows a flowchart illustrating a method 1700 that supports resource scheduling for sparse non-orthogonal transmissions in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting, to a network entity, an indication of a pathloss value for a communication channel between the UE and the network entity and an uplink power for the UE. The operations of block 1705 may be performed in accordance with examples as disclosed herein. In some examples, aspects of the operations of 1705 may be performed by a communication channel parameter manager 1125 as described with reference to FIG. 11.

At 1710, the method may include receiving, from the network entity and based on the pathloss value and the uplink power, scheduling information for an uplink communication, where the scheduling information includes a resource mapping vector indicative of an assigned subset of orthogonal resources of a set of multiple orthogonal resources and a repetition code for the uplink communication. The operations of block 1710 may be performed in accordance with examples as disclosed herein. In some examples, aspects of the operations of 1710 may be performed by an uplink scheduling manager 1130 as described with reference to FIG. 11.

At 1715, the method may include transmitting, to the network entity and via the assigned subset of orthogonal resources, the uplink communication in accordance with the repetition code. The operations of block 1715 may be performed in accordance with examples as disclosed herein. In some examples, aspects of the operations of 1715 may be performed by an uplink transmission manage 1135 as described with reference to FIG. 11.

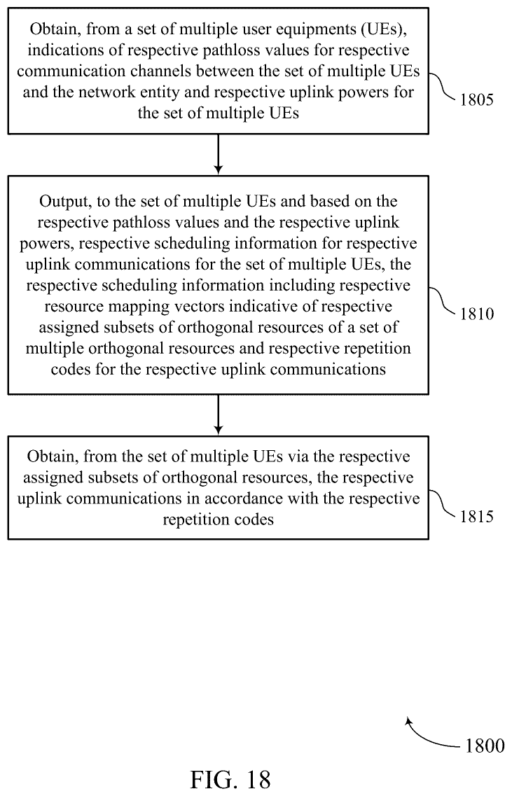

FIG. 18 shows a flowchart illustrating a method 1800 that supports resource scheduling for sparse non-orthogonal transmissions in accordance with aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include obtaining, from a set of multiple user equipments (UEs), indications of respective pathloss values for respective communication channels between the set of multiple UEs and the network entity and respective uplink powers for the set of multiple UEs. The operations of block 1805 may be performed in accordance with examples as disclosed herein. In some examples, aspects of the operations of 1805 may be performed by a communication channel parameter manager 1525 as described with reference to FIG. 15.

At 1810, the method may include outputting, to the set of multiple UEs and based on the respective pathloss values and the respective uplink powers, respective scheduling information for respective uplink communications for the set of multiple UEs, the respective scheduling information including respective resource mapping vectors indicative of respective assigned subsets of orthogonal resources of a set of multiple orthogonal resources and respective repetition codes for the respective uplink communications. The operations of block 1810 may be performed in accordance with examples as disclosed herein. In some examples, aspects of the operations of 1810 may be performed by an uplink scheduling manager 1530 as described with reference to FIG. 15.

At 1815, the method may include obtaining, from the set of multiple UEs via the respective assigned subsets of orthogonal resources, the respective uplink communications in accordance with the respective repetition codes. The operations of block 1815 may be performed in accordance with examples as disclosed herein. In some examples, aspects of the operations of 1815 may be performed by an uplink reception manager 1535 as described with reference to FIG. 15.

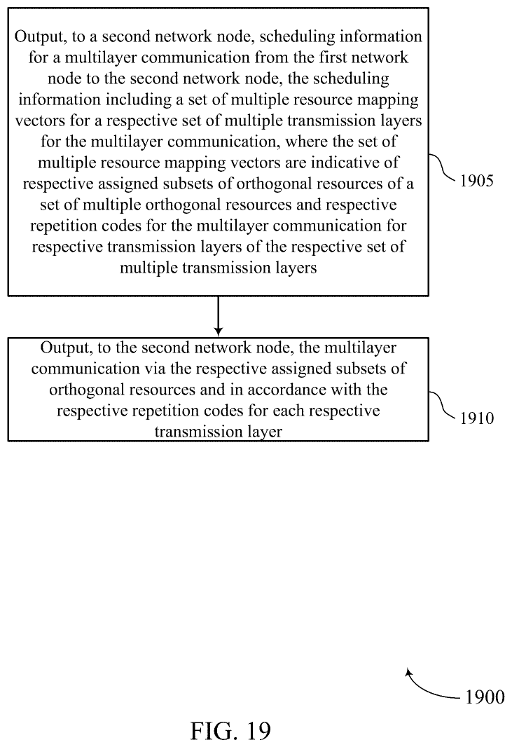

FIG. 19 shows a flowchart illustrating a method 1900 that supports resource scheduling for sparse non-orthogonal transmissions in accordance with aspects of the present disclosure. The operations of the method 1900 may be implemented by a UE or a network entity or its components as described herein. For example, the operations of the method 1900 may be performed by a UE 115 as described with reference to FIGS. 1 through 12 or a network entity as described with reference to FIGS. 1 through 8 and 13 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include outputting, to a second network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The operations of block 1905 may be performed in accordance with examples as disclosed herein. In some examples, aspects of the operations of 1905 may be performed by a multi-layer transmission scheduling manager 1140 or a multi-layer transmission scheduling manager 1540 as described with reference to FIGS. 11 and 15.

At 1910, the method may include outputting, to the second network node, the multilayer communication via the respective assigned subsets of orthogonal resources and in accordance with the respective repetition codes for each respective transmission layer. The operations of block 1910 may be performed in accordance with examples as disclosed herein. In some examples, aspects of the operations of 1910 may be performed by a multi-layer transmission manager 1145 or a multi-layer transmission manager 1545 as described with reference to FIGS. 11 and 15.

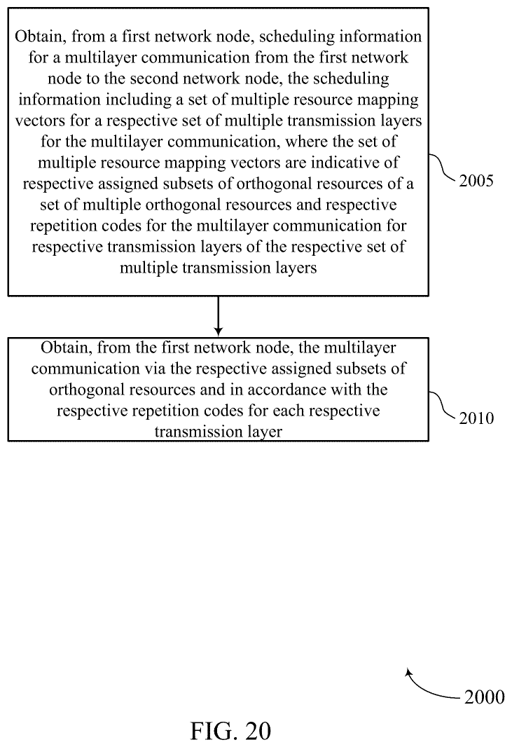

FIG. 20 shows a flowchart illustrating a method 2000 that supports resource scheduling for sparse non-orthogonal transmissions in accordance with aspects of the present disclosure. The operations of the method 2000 may be implemented by a UE or a network entity or its components as described herein. For example, the operations of the method 2000 may be performed by a UE 115 as described with reference to FIGS. 1 through 12 or a network entity as described with reference to FIGS. 1 through 8 and 13 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 2005, the method may include obtaining, from a first network node, scheduling information for a multilayer communication from the first network node to the second network node, the scheduling information including a set of multiple resource mapping vectors for a respective set of multiple transmission layers for the multilayer communication, where the set of multiple resource mapping vectors are indicative of respective assigned subsets of orthogonal resources of a set of multiple orthogonal resources and respective repetition codes for the multilayer communication for respective transmission layers of the respective set of multiple transmission layers. The operations of block 2005 may be performed in accordance with examples as disclosed herein. In some examples, aspects of the operations of 2005 may be performed by a multi-layer transmission scheduling manager 1140 or a multi-layer transmission scheduling manager 1540 as described with reference to FIGS. 11 and 15.

At 2010, the method may include obtaining, from the first network node, the multilayer communication via the respective assigned subsets of orthogonal resources and in accordance with the respective repetition codes for each respective transmission layer. The operations of block 2010 may be performed in accordance with examples as disclosed herein. In some examples, aspects of the operations of 2010 may be performed by a multi-layer reception manager 1150 or a multi-layer reception manager 1550 as described with reference to FIGS. 11 and 15.

The following provides an overview of aspects of the present disclosure:

Aspect 1: A method for wireless communications at a UE, comprising: transmitting, to a network entity, an indication of a pathloss value for a communication channel between the UE and the network entity and an uplink power for the UE; receiving, from the network entity and based at least in part on the pathloss value and the uplink power, scheduling information for an uplink communication, wherein the scheduling information comprises a resource mapping vector indicative of an assigned subset of orthogonal resources of a plurality of orthogonal resources and a repetition code for the uplink communication; and transmitting, to the network entity and via the assigned subset of orthogonal resources, the uplink communication in accordance with the repetition code.

Aspect 2: The method of aspect 1, further comprising: transmitting, to the network entity and subsequent to transmission of the uplink communication, an update to at least one of the pathloss value or the uplink power; receiving, from the network entity and based at least in part on the update, second scheduling information for a second uplink communication, wherein the second scheduling information comprises a second resource mapping vector indicative of a second assigned subset of orthogonal resources of the plurality of orthogonal resources and a second repetition code for the second uplink communication; and transmitting, to the network entity and via the second assigned subset of orthogonal resources, the second uplink communication in accordance with the repetition code.

Aspect 3: The method of any of aspects 1 through 2, wherein a length of the repetition code is equal to a quantity of orthogonal resources of the plurality of orthogonal resources.

Aspect 4: The method of any of aspects 1 through 3, wherein the plurality of orthogonal resources are shared for a plurality of UEs, and the plurality of UEs includes the UE.

Aspect 5: The method of aspect 4, wherein a quantity of UEs of the plurality of UEs is greater than a quantity of orthogonal resources of the plurality of orthogonal resources.

Aspect 6: The method of any of aspects 4 through 5, wherein a quantity of assigned orthogonal resources for each of the plurality of UEs is equal.

Aspect 7: The method of any of aspects 1 through 6, wherein the plurality of orthogonal resources are a plurality of frequency resources associated with a same time resource.

Aspect 8: The method of aspect 7, wherein the assigned subset of orthogonal resources comprise two or more adjacent frequency resources of the plurality of frequency resources.

Aspect 9: The method of any of aspects 1 through 8, wherein transmitting the uplink communication comprises: transmitting the uplink communication via a plurality of transmission layers, wherein the resource mapping vector indicates which orthogonal resource of the assigned subset of orthogonal resources are assigned to which of the plurality of transmission layers.

Aspect 10: A method for wireless communications at a network entity, comprising: obtaining, from a plurality of UEs, indications of respective pathloss values for respective communication channels between the plurality of UEs and the network entity and respective uplink powers for the plurality of UEs; outputting, to the plurality of UEs and based at least in part on the respective pathloss values and the respective uplink powers, respective scheduling information for respective uplink communications for the plurality of UEs, the respective scheduling information comprising respective resource mapping vectors indicative of respective assigned subsets of orthogonal resources of a plurality of orthogonal resources and respective repetition codes for the respective uplink communications; and obtaining, from the plurality of UEs via the respective assigned subsets of orthogonal resources, the respective uplink communications in accordance with the respective repetition codes.

Aspect 11: The method of aspect 10, further comprising: obtaining, from at least one of the plurality of UEs, an update to at least one of the respective pathloss values or the respective uplink powers; outputting, to the plurality of UEs and based at least in part on the update, second respective scheduling information for second respective uplink communications for the plurality of UEs, the second respective scheduling information comprising second respective resource mapping vectors indicative of second respective assigned subsets of orthogonal resources of the plurality of orthogonal resources and second respective repetition codes for the second respective uplink communications; and obtaining, from the plurality of UEs via the second respective assigned subsets of orthogonal resources, the second respective uplink communications in accordance with the second respective repetition codes.

Aspect 12: The method of any of aspects 10 through 11, wherein a length of the respective repetition codes is equal to a quantity of orthogonal resources of the plurality of orthogonal resources.

Aspect 13: The method of any of aspects 10 through 12, wherein a quantity of UEs of the plurality of UEs is greater than a quantity of orthogonal resources of the plurality of orthogonal resources.

Aspect 14: The method of aspect 13, wherein a quantity of orthogonal resources in each of the respective assigned subsets of orthogonal resources is equal.

Aspect 15: The method of any of aspects 10 through 14, wherein the plurality of orthogonal resources are a plurality of frequency resources associated with a same time resource.

Aspect 16: The method of aspect 15, wherein the respective assigned subsets of orthogonal resources each comprise two or more adjacent frequency resources of the plurality of frequency resources.

Aspect 17: The method of any of aspects 10 through 16, wherein obtaining the respective uplink communications comprises: obtaining each of the respective uplink communications via a respective plurality of transmission layers, wherein each of the respective resource mapping vectors indicates which orthogonal resources of the respective assigned subsets of orthogonal resources are assigned to which of the respective plurality of transmission layers.

Aspect 18: A method for wireless communications at a first network node, comprising: outputting, to a second network node, scheduling information for a multilayer communication from the first network node to the second network node, the scheduling information comprising a plurality of resource mapping vectors for a respective plurality of transmission layers for the multilayer communication, wherein the plurality of resource mapping vectors are indicative of respective assigned subsets of orthogonal resources of a plurality of orthogonal resources and respective repetition codes for the multilayer communication for respective transmission layers of the respective plurality of transmission layers; and outputting, to the second network node, the multilayer communication via the respective assigned subsets of orthogonal resources and in accordance with the respective repetition codes for each respective transmission layer.

Aspect 19: The method of aspect 18, further comprising: identifying respective pathloss values for respective communication channels between the first network node and the second network node for the respective plurality of transmission layers; and identifying respective transmission powers for the respective plurality of transmission layers, wherein the plurality of resource mapping vectors are based at least in part on the respective pathloss values and the respective transmission powers.

Aspect 20: The method of aspect 19, further comprising: identifying an update to at least one of the respective pathloss values or the respective transmission powers; outputting, to the second network node, second scheduling information for a second multilayer communication from the first network node to the second network node, the second scheduling information comprising a second plurality of resource mapping vectors for the respective plurality of transmission layers for the multilayer communication, wherein the second plurality of resource mapping vectors are indicative of respective second assigned subsets of orthogonal resources of the plurality of orthogonal resources and respective second repetition codes for the second multilayer communication for the respective transmission layers of the respective plurality of transmission layers, wherein the second plurality of resource mapping vectors are based at least in part on the update; and outputting, to the second network node, the second multilayer communication via the respective second assigned subsets of orthogonal resources and in accordance with the respective second repetition codes for each respective transmission layer.

Aspect 21: The method of any of aspects 18 through 20, wherein a length of each of the respective repetition codes is equal to a quantity of orthogonal resources of the plurality of orthogonal resources.

Aspect 22: The method of any of aspects 18 through 21, wherein a quantity of layers of the respective plurality of transmission layers is greater than a quantity of orthogonal resources of the plurality of orthogonal resources.

Aspect 23: The method of any of aspects 18 through 22, wherein a quantity of orthogonal resources in each of the respective assigned subsets of orthogonal resources is equal.

Aspect 24: The method of any of aspects 18 through 23, wherein the plurality of orthogonal resources are a plurality of frequency resources associated with a same time resource.

Aspect 25: The method of aspect 24, wherein each of the respective assigned subsets of orthogonal resources comprise two or more adjacent frequency resources of the plurality of frequency resources.

Aspect 26: The method of any of aspects 18 through 25, wherein outputting the multilayer communication comprises: outputting an uplink communication to a network entity, wherein the first network node is a UE, and wherein the second network node is the network entity.

Aspect 27: The method of any of aspects 18 through 26, wherein outputting the multilayer communication comprises: outputting a downlink communication to a UE, wherein the first network node is a network entity, and wherein the second network node is the UE.

Aspect 28: A method for wireless communications at a second network node, comprising: obtaining, from a first network node, scheduling information for a multilayer communication from the first network node to the second network node, the scheduling information comprising a plurality of resource mapping vectors for a respective plurality of transmission layers for the multilayer communication, wherein the plurality of resource mapping vectors are indicative of respective assigned subsets of orthogonal resources of a plurality of orthogonal resources and respective repetition codes for the multilayer communication for respective transmission layers of the respective plurality of transmission layers; and obtaining, from the first network node, the multilayer communication via the respective assigned subsets of orthogonal resources and in accordance with the respective repetition codes for each respective transmission layer.

Aspect 29: The method of aspect 28, wherein the plurality of resource mapping vectors are based at least in part on respective pathloss values for respective communication channels between the first network node and the second network node for the respective plurality of transmission layers and respective transmission powers for the respective plurality of transmission layers.

Aspect 30: The method of aspect 29, further comprising: obtaining, from the first network node and based at least in part on an update to at least one of the respective pathloss values or the respective transmission powers, second scheduling information for a second multilayer communication from the first network node to the second network node, the second scheduling information comprising a second plurality of resource mapping vectors for the respective plurality of transmission layers for the multilayer communication, wherein the second plurality of resource mapping vectors are indicative of respective second assigned subsets of orthogonal resources of the plurality of orthogonal resources and respective second repetition codes for the second multilayer communication for the respective transmission layers of the respective plurality of transmission layers, wherein the second plurality of resource mapping vectors are based at least in part on the update; and obtaining, from the first network node, the second multilayer communication via the respective second assigned subsets of orthogonal resources and in accordance with the respective second repetition codes for each respective transmission layer.

Aspect 31: The method of any of aspects 28 through 30, wherein a length of each of the respective repetition codes is equal to a quantity of orthogonal resources of the plurality of orthogonal resources.

Aspect 32: The method of any of aspects 28 through 31, wherein a quantity of layers of the respective plurality of transmission layers is greater than a quantity of orthogonal resources of the plurality of orthogonal resources.

Aspect 33: The method of any of aspects 28 through 32, wherein a quantity of orthogonal resources in each of the respective assigned subsets of orthogonal resources is equal.

Aspect 34: The method of any of aspects 28 through 33, wherein the plurality of orthogonal resources are a plurality of frequency resources associated with a same time resource.

Aspect 35: The method of aspect 34, wherein each of the respective assigned subsets of orthogonal resources comprise two or more adjacent frequency resources of the plurality of frequency resources.

Aspect 36: The method of any of aspects 28 through 35, wherein obtaining the multilayer communication comprises: obtaining an uplink communication from a UE, wherein the first network node is the UE, and wherein the second network node is a network entity.

Aspect 37: The method of any of aspects 28 through 36, wherein obtaining the multilayer communication comprises: obtaining a downlink communication from a network entity, wherein the first network node is the network entity, and wherein the second network node is a UE.

Aspect 38: A UE for wireless communications, comprising one or more memories storing processor-executable code, and one or more processors coupled with the one or more memories and individually or collectively operable to execute the code to cause the UE to perform a method of any of aspects 1 through 9.

Aspect 39: A UE for wireless communications, comprising at least one means for performing a method of any of aspects 1 through 9.

Aspect 40: A non-transitory computer-readable medium storing code for wireless communications, the code comprising instructions executable by one or more processors to perform a method of any of aspects 1 through 9.

Aspect 41: A network entity for wireless communications, comprising one or more memories storing processor-executable code, and one or more processors coupled with the one or more memories and individually or collectively operable to execute the code to cause the network entity to perform a method of any of aspects 10 through 17.

Aspect 42: A network entity for wireless communications, comprising at least one means for performing a method of any of aspects 10 through 17.

Aspect 43: A non-transitory computer-readable medium storing code for wireless communications, the code comprising instructions executable by one or more processors to perform a method of any of aspects 10 through 17.

Aspect 44: A first network node for wireless communications, comprising one or more memories storing processor-executable code, and one or more processors coupled with the one or more memories and individually or collectively operable to execute the code to cause the first network node to perform a method of any of aspects 18 through 27.

Aspect 45: A first network node for wireless communications, comprising at least one means for performing a method of any of aspects 18 through 27.

Aspect 46: A non-transitory computer-readable medium storing code for wireless communications, the code comprising instructions executable by one or more processors to perform a method of any of aspects 18 through 27.

Aspect 47: A second network node for wireless communications, comprising one or more memories storing processor-executable code, and one or more processors coupled with the one or more memories and individually or collectively operable to execute the code to cause the second network node to perform a method of any of aspects 28 through 37.

Aspect 48: A second network node for wireless communications, comprising at least one means for performing a method of any of aspects 28 through 37.

Aspect 49: A non-transitory computer-readable medium storing code for wireless communications, the code comprising instructions executable by one or more processors to perform a method of any of aspects 28 through 37.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity, an indication of a pathloss value for a communication channel between the UE and the network entity and an uplink power for the UE;
receive, from the network entity and based at least in part on the pathloss value and the uplink power, scheduling information for an uplink communication, wherein the scheduling information comprises a resource mapping vector indicative of an assigned subset of orthogonal resources of a plurality of orthogonal resources and a repetition code for the uplink communication; and
transmit, to the network entity and via the assigned subset of orthogonal resources, the uplink communication in accordance with the repetition code.

2. The UE of claim 1, wherein the one or more processors are individually or collectively further operable to execute the code to cause the UE to:
transmit, to the network entity and subsequent to transmission of the uplink communication, an update to at least one of the pathloss value or the uplink power;
receive, from the network entity and based at least in part on the update, second scheduling information for a second uplink communication, wherein the second scheduling information comprises a second resource mapping vector indicative of a second assigned subset of orthogonal resources of the plurality of orthogonal resources and a second repetition code for the second uplink communication; and
transmit, to the network entity and via the second assigned subset of orthogonal resources, the second uplink communication in accordance with the repetition code.

3. The UE of claim 1, wherein a length of the repetition code is equal to a quantity of orthogonal resources of the plurality of orthogonal resources.

4. The UE of claim 1, wherein:
the plurality of orthogonal resources are shared for a plurality of UEs, and
the plurality of UEs includes the UE.

5. The UE of claim 4, wherein a quantity of UEs of the plurality of UEs is greater than a quantity of orthogonal resources of the plurality of orthogonal resources.

6. The UE of claim 4, wherein a quantity of assigned orthogonal resources for each of the plurality of UEs is equal.

7. The UE of claim 1, wherein the plurality of orthogonal resources are a plurality of frequency resources associated with a same time resource.

8. The UE of claim 7, wherein the assigned subset of orthogonal resources comprise two or more adjacent frequency resources of the plurality of frequency resources.

9. The UE of claim 1, wherein, to transmit the uplink communication, the one or more processors are individually or collectively operable to execute the code to cause the UE to:
transmit the uplink communication via a plurality of transmission layers, wherein the resource mapping vector indicates which orthogonal resource of the assigned subset of orthogonal resources are assigned to which of the plurality of transmission layers.

10. A network entity, comprising:
one or more memories storing processor-executable code; and
one or more processors coupled with the one or more memories and individually or collectively operable to execute the code to cause the network entity to:
obtain, from a plurality of user equipments (UEs), indications of respective pathloss values for respective communication channels between the plurality of UEs and the network entity and respective uplink powers for the plurality of UEs;
output, to the plurality of UEs and based at least in part on the respective pathloss values and the respective uplink powers, respective scheduling information for respective uplink communications for the plurality of UEs, the respective scheduling information comprising respective resource mapping vectors indicative of respective assigned subsets of orthogonal resources of a plurality of orthogonal resources and respective repetition codes for the respective uplink communications; and
obtain, from the plurality of UEs via the respective assigned subsets of orthogonal resources, the respective uplink communications in accordance with the respective repetition codes.

11. The network entity of claim 10, wherein the one or more processors are individually or collectively further operable to execute the code to cause the network entity to:
obtain, from at least one of the plurality of UEs, an update to at least one of the respective pathloss values or the respective uplink powers;
output, to the plurality of UEs and based at least in part on the update, second respective scheduling information for second respective uplink communications for the plurality of UEs, the second respective scheduling information comprising second respective resource mapping vectors indicative of second respective assigned subsets of orthogonal resources of the plurality of orthogonal resources and second respective repetition codes for the second respective uplink communications; and
obtain, from the plurality of UEs via the second respective assigned subsets of orthogonal resources, the second respective uplink communications in accordance with the second respective repetition codes.

12. The network entity of claim 10, wherein a length of the respective repetition codes is equal to a quantity of orthogonal resources of the plurality of orthogonal resources.

13. The network entity of claim 10, wherein a quantity of UEs of the plurality of UEs is greater than a quantity of orthogonal resources of the plurality of orthogonal resources.

14. The network entity of claim 13, wherein:
a quantity of orthogonal resources in each of the respective assigned subsets of orthogonal resources is equal.

15. The network entity of claim 10, wherein the plurality of orthogonal resources are a plurality of frequency resources associated with a same time resource.

16. The network entity of claim 15, wherein the respective assigned subsets of orthogonal resources each comprise two or more adjacent frequency resources of the plurality of frequency resources.

17. The network entity of claim 10, wherein, to obtain the respective uplink communications, the one or more processors are individually or collectively operable to execute the code to cause the network entity to:
obtain each of the respective uplink communications via a respective plurality of transmission layers, wherein each of the respective resource mapping vectors indicates which orthogonal resources of the respective assigned subsets of orthogonal resources are assigned to which of the respective plurality of transmission layers.

18. A first network node, comprising:
one or more memories storing processor-executable code; and
one or more processors coupled with the one or more memories and individually or collectively operable to execute the code to cause the first network node to:
output, to a second network node, scheduling information for a multilayer communication from the first network node to the second network node, the scheduling information comprising a plurality of resource mapping vectors for a respective plurality of transmission layers for the multilayer communication, wherein the plurality of resource mapping vectors are indicative of respective assigned subsets of orthogonal resources of a plurality of orthogonal resources and respective repetition codes for the multilayer communication for respective transmission layers of the respective plurality of transmission layers; and
output, to the second network node, the multilayer communication via the respective assigned subsets of orthogonal resources and in accordance with the respective repetition codes for each respective transmission layer.

19. The first network node of claim 18, wherein the one or more processors are individually or collectively further operable to execute the code to cause the first network node to:
identify respective pathloss values for respective communication channels between the first network node and the second network node for the respective plurality of transmission layers; and
identify respective transmission powers for the respective plurality of transmission layers, wherein the plurality of resource mapping vectors are based at least in part on the respective pathloss values and the respective transmission powers.

20. The first network node of claim 19, wherein the one or more processors are individually or collectively further operable to execute the code to cause the first network node to:
identify an update to at least one of the respective pathloss values or the respective transmission powers;
output, to the second network node, second scheduling information for a second multilayer communication from the first network node to the second network node, the second scheduling information comprising a second plurality of resource mapping vectors for the respective plurality of transmission layers for the multilayer communication, wherein the second plurality of resource mapping vectors are indicative of respective second assigned subsets of orthogonal resources of the plurality of orthogonal resources and respective second repetition codes for the second multilayer communication for the respective transmission layers of the respective plurality of transmission layers, wherein the second plurality of resource mapping vectors are based at least in part on the update; and
output, to the second network node, the second multilayer communication via the respective second assigned subsets of orthogonal resources and in accordance with the respective second repetition codes for each respective transmission layer.

21. The first network node of claim 18, wherein a length of each of the respective repetition codes is equal to a quantity of orthogonal resources of the plurality of orthogonal resources.

22. The first network node of claim 18, wherein a quantity of layers of the respective plurality of transmission layers is greater than a quantity of orthogonal resources of the plurality of orthogonal resources.

23. The first network node of claim 18, wherein:
a quantity of orthogonal resources in each of the respective assigned subsets of orthogonal resources is equal.

24. The first network node of claim 18, wherein the plurality of orthogonal resources are a plurality of frequency resources associated with a same time resource.

25. The first network node of claim 24, wherein each of the respective assigned subsets of orthogonal resources comprise two or more adjacent frequency resources of the plurality of frequency resources.

26. The first network node of claim 18, wherein, to output the multilayer communication, the one or more processors are individually or collectively operable to execute the code to cause the first network node to:
output an uplink communication to a network entity, wherein the first network node is a user equipment (UE), and wherein the second network node is the network entity.

27. The first network node of claim 18, wherein, to output the multilayer communication, the one or more processors are individually or collectively operable to execute the code to cause the first network node to:
output a downlink communication to a user equipment (UE), wherein the first network node is a network entity, and wherein the second network node is the UE.

28. A second network node, comprising:
one or more memories storing processor-executable code; and
one or more processors coupled with the one or more memories and individually or collectively operable to execute the code to cause the second network node to:
obtain, from a first network node, scheduling information for a multilayer communication from the first network node to the second network node, the scheduling information comprising a plurality of resource mapping vectors for a respective plurality of transmission layers for the multilayer communication, wherein the plurality of resource mapping vectors are indicative of respective assigned subsets of orthogonal resources of a plurality of orthogonal resources and respective repetition codes for the multilayer communication for respective transmission layers of the respective plurality of transmission layers; and
obtain, from the first network node, the multilayer communication via the respective assigned subsets of orthogonal resources and in accordance with the respective repetition codes for each respective transmission layer.

29. The second network node of claim 28, wherein the plurality of resource mapping vectors are based at least in part on respective pathloss values for respective communication channels between the first network node and the second network node for the respective plurality of transmission layers and respective transmission powers for the respective plurality of transmission layers.

30. The second network node of claim 29, wherein the one or more processors are individually or collectively further operable to execute the code to cause the second network node to:
obtain, from the first network node and based at least in part on an update to at least one of the respective pathloss values or the respective transmission powers, second scheduling information for a second multilayer communication from the first network node to the second network node, the second scheduling information comprising a second plurality of resource mapping vectors for the respective plurality of transmission layers for the multilayer communication, wherein the second plurality of resource mapping vectors are indicative of respective second assigned subsets of orthogonal resources of the plurality of orthogonal resources and respective second repetition codes for the second multilayer communication for the respective transmission layers of the respective plurality of transmission layers, wherein the second plurality of resource mapping vectors are based at least in part on the update; and
obtain, from the first network node, the second multilayer communication via the respective second assigned subsets of orthogonal resources and in accordance with the respective second repetition codes for each respective transmission layer.
